(19) United States
(12) Patent Application Publication
(10) Pub. No.: US 2008/0019670 A1
(43) Pub. Date: Jan. 24, 2008

(54) Information processing apparatus, information processing method, and computer program

(75) Inventor: Kenji Yoshida, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/825,673

(22) Filed: Jul. 6, 2007

(30) Foreign Application Priority Data
Jul. 11, 2006 (JP) P2006-190007

(51) Int. Cl. H04N 5/00

(52) U.S. Cl. 386/117

(57) ABSTRACT

An information processing apparatus that loads a disc as a recording medium and performs a data recording process on the disc may include a display unit performing an information display process and a control unit displaying guide information including predetermined inquiry information for a user in the display unit and performing an analysis process for a user's input that is input through an input unit in response to the displayed guide information, wherein the control unit may be configured to determine a usage type of recording data for the disc on the basis of the user's input in response to the guide information displayed in the display unit and determine at least one of a disc type and an application format that is to be used for the recording process.

### CROSS-REFERENCE TO RELATED APPLICATIONS

This application claims priority from Japanese Patent Application No. JP 2006-190007 filed in the Japanese Patent Office on Jul. 11, 2006, the entire content of which is incorporated herein by reference.

### BACKGROUND OF THE INVENTION

1. Technical Field

The present invention relates to an information processing apparatus, an information processing method, and a computer program, and more particularly, to an information processing apparatus, an information processing method, and a computer program that enable users to easily select an optimal disc or an optimal application format for an apparatus such as a camcorder performing a recording process using a disc including a DVD (Digital Versatile Disc) or the like.

Described in more details, the present invention relates to an information processing apparatus, an information processing method, and a computer program that enable users to easily select an optimal disc or an application format by displaying guide in a display unit and enabling the user to perform selection in a wizard mode (interactive mode) for the selection of the disc or the application format.

2. Background Art

As recording media for various information recoding apparatuses such as camcorders, DVDs (Digital Versatile Discs) are used. However, since there are various types of the DVDs, there are many cases where users have difficulties in selecting appropriate types of the DVDs. There are DVD-R, DVD+R, DVD-RW, DVD+RW and the like as the types of the DVDS. It is difficult for many of the users to accurately determine optimal discs among the DVDs.

In addition, it may be required to perform a formatting process for a DVD before starting data recording for the DVD after the type of the DVD is selected. In other words, a specific application format of a DVD is determined, and then, data recording is performed for the DVD in accordance with the determined application format. However, there are a plurality of application formats of the DVD.

For example, there are a DVD-Video format, a DVD+RW Video format, a DVD Video Recording format (VR format), and the like as the application formats of the DVD. These application formats have differences in easiness of editing data recorded on discs and necessity for a finalization process as a process for reproduction of other players, and the like.

However, since there are many cases where ordinary users do not know the types of the application formats and the differences among the application formats clearly, it is difficult for the users to determine the application format to be used for data recording.

When a user performs data recording, there may be various objects of the data recording such as for a case where recording in a high definition image quality may be required, a case where recording for a long time in a standard definition may be required, a case where editing of recording data may be performed, and a case where preservation of recording data may be required without editing of the recording data, and accordingly it is preferable to select an optimal disc and an optimal application format that respond to the object of the data recording.

### SUMMARY OF THE INVENTION

The present invention is contrived in consideration with this situation so as to provide an information processing apparatus, an information processing method, and a computer program that enable users to easily select an optimal disc or an optimal application format for an apparatus such as a camcorder that performs a recording process using a disc including a DVD (Digital Versatile Disc) or the like.

Described in more details, according to embodiments of the present invention, there are provided an information processing apparatus, an information processing method, and a computer program that enable users to easily select an optimal disc or an application format by displaying guide in a display unit and enabling the user to perform selection in a wizard mode (interactive mode) for the selection of the disc or the application format.

According to an embodiment of the present invention, there is provided an information processing apparatus that loads a disc as a recording medium and performs a data recording process on the disc. The information processing apparatus may include a display unit performing an information display process and a control unit displaying guide information including predetermined inquiry information for a user in the display unit and performing an analysis process for a user's input that is input through an input unit in response to the displayed guide information. The control unit may be configured to determine a usage type of recording data for the disc on the basis of the user's input in response to the guide information displayed in the display unit and determine at least one of a disc type and an application format that is to be used for the recording process.

The control unit may be configured to determine the usage type of the recording data for the disc in accordance with the user's input in response to the guide information displayed in the display unit and determine at least one of a disc type and an application format that is to be used for the recording process, on the basis of setting information on a combination of the disc type and the application format optimal for the usage type of the recording data for the disc.

The guide information may include at least inquiry information on an image quality of the recording data.

The guide information may include at least inquiry information on an editing process for the recording data to be recorded on the disc.

The guide information may include at least inquiry information on whether the disc on which the recording data is recorded is to be reproduced using an apparatus other than the information processing apparatus.

The guide information may include at least inquiry information on whether the recording data is to be repeatedly recorded on the disc.

The control unit may be configured to display an image quality checking guide screen for inquiring a desired recording type between a high definition (HD) recording type and a standard definition (SD) recording type in the display unit and determine at least one of the disc type and the an application format that is to be used for the recording process on the basis of the user's input in response to the image quality checking guide screen.

The control unit may be configured to display a disc usage checking guide screen for inquiring whether preservation of the data to be recorded on the disc may be required or deletion of the data recorded on the disc and reuse of the disc may be required in the display unit and determine at least one of the disc type and the application format that is to be used for the recording process on the basis of the user's input for the disc usage checking guide screen.

The control unit may be configured to display a recording data usage type checking guide screen for inquiring whether the data to be recorded on the disc is to be reproduced by an apparatus other than the information processing apparatus or is to be edited by the information processing apparatus in the display unit and determine at least one of the disc type and the application format that is to be used for the recording process on the basis of the user's input in response to the recording data usage type checking guide screen.

The control unit may be configured to determine the usage type of the recording data for the disc on the basis of user's input in response to the guide information displayed in the display unit, determine a recommended disc type that is appropriate for the recording process, and display a disc loading requesting guide screen in the display unit for prompting loading of the determined disc type when the disc is not loaded in the information processing apparatus.

The control unit may be configured to display an identification mark corresponding to each disc type in the disc loading requesting guide screen.

The control unit may be configured to identify the type of a loaded disc and determine the application format to be used for the recording process for the disc of which type is identified on the basis of the user's input in response to the guide information displayed in the displayed unit when the disc is loaded in the information processing apparatus.

The control unit may be configured to display an initiating screen for an initialization process in the display unit, display the guide information in the display unit, determine the usage type of the recording data for the disc on the basis of the user's input in response to the guide information, and determine the application format to be used for the recording process when it is detected that the disc loaded in the information processing apparatus is an unused disc.

According to another embodiment of the invention, there is provided an information processing method using an information processing apparatus that loads a disc as a recording medium and performs a data recording process on the disc. The information processing method may include the steps of displaying guide information including predetermined inquiry information for a user in the display unit using a control unit and performing a determination process using the control unit to decide at least one of a disc type and an application format that is to be used for the recording process by determining a usage type of recording data for the disc on the basis of an analysis process for the user's input through the input unit in response to the guide information, using the control unit.

The determination process performing step may determine the usage type of the recording data for the disc in accordance with the user's input in response to the guide information displayed in the display unit and determine at least one of a disc type and an application format that is to be used for the recording process, on the basis of setting information on a combination of the disc type and the application format optimal for the usage type of the recording data for the disc.

The guide information may include at least inquiry information on an image quality of the recording data.

The guide information may include at least inquiry information on an editing process for the recording data to be recorded on the disc.

The guide information may include at least inquiry information on whether the disc on which the recording data is recorded is to be reproduced using an apparatus other than the information processing apparatus.

The guide information may include at least inquiry information on whether the recording data is to be repeatedly recorded on the disc.

The determination process performing step may include displaying an image quality checking guide screen for inquiring a desired recording type between a high definition (HD) recording type and a standard definition (SD) recording type in the display unit and determining at least one of the disc type and the an application format that is to be used for the recording process on the basis of the user's input in response to the image quality checking guide screen.

The determination process performing step may include displaying a disc usage checking guide screen for inquiring whether preservation of the data to be recorded on the disc may be required or deletion of the data recorded on the disc and reuse of the disc may be required in the display unit and determining at least one of the disc type and the application format that is to be used for the recording process on the basis of the user's input for the disc usage checking guide screen.

The determination process performing step may include displaying a recording data usage type checking guide screen for inquiring whether the data to be recorded on the disc is to be reproduced by an apparatus other than the information processing apparatus or is to be edited by the information processing apparatus in the display unit and determining at least one of the disc type and the application format that is to be used for the recording process on the basis of the user's input in response to the recording data usage type checking guide screen.

The information processing method may further include determining the usage type of the recording data for the disc on the basis of user's input in response to the guide information displayed in the display unit, determining a recommended disc type that is appropriate for the recording process, and displaying a disc loading requesting guide screen in the display unit for prompting loading of the determined disc type under the control of the control unit when the disc is not loaded in the information processing apparatus.

The guide information displaying step may display an identification mark corresponding to each disc type in the disc loading requesting guide screen.

The information processing method may further include identifying the type of a loaded disc and determining the application format to be used for the recording process for the disc of which type is identified on the basis of the user's input in response to the guide information displayed in the displayed unit, by using the control unit, when the disc is loaded in the information processing apparatus.

The information processing method may further include displaying an initiating screen for an initialization process in the display unit, displaying the guide information in the display unit, determining the usage type of the recording data for the disc on the basis of the user's input in response to the guide information, and determining the application format to be used for the recording process, using the control unit, when it is detected that the disc loaded in the information processing apparatus is an unused disc.

According to another embodiment of the invention, there is provided a computer program performing an information process using an information processing apparatus that loads a disc as a recording medium and performs a data recording process on the disc. The computer program may perform the steps of displaying guide information including predetermined inquiry information for a user in the display unit using a control unit and performing a determination process using the control unit to decide at least one of a disc type and an application format that is to be used for the recording process by determining a usage type of recording data for the disc on the basis of an analysis process for the user's input through the input unit in response to the guide information, using the control unit.

The computer program according to an embodiment of the invention may be provided on a storage medium such as a CD, an FD, and an MO or a communication medium such as a network in a computer-readable form, for example, for a general-purpose computer capable of executing various program codes. By providing the program in the computer-readable form, a process in accordance with the program is performed in a computer system.

Other goals, features, and advantages of the present invention will be disclosed by detailed description on the basis of embodiments of the invention to be described later or attached drawings. A system in description of an embodiment of the invention is a configuration of a logical set of a plurality of devices and is not limited to a configuration in which all the devices are integrated in one body.

According to a configuration of an embodiment of the present invention, since there is used a configuration in which guide information configured as an interactive mode for a user is displayed in the display unit, a user's input through the input unit is analyzed, a usage type of recording data for the disc is determined on the basis of the user's input in response to the guide information displayed in the display unit, and a disc type or an application format to be used for data recording is determined, the user can select an optimal disc and an optimal application format in accordance with the usage type of recording data by only sequentially responding to inquiries displayed in the display unit of the information processing apparatus, and processes that may be required after the selection can be performed assuredly, whereby a data recording operation in which the optical application format is used for the optical disc can be started smoothly.

### BRIEF DESCRIPTION OF THE DRAWINGS

FIG. 1 is a diagram for description of disc usage types of an information processing apparatus according to an embodiment of the present invention.

FIG. 2 is a diagram for description of disc types (physical formats) of discs.

FIG. 3 is a diagram for description of types of application formats.

FIG. 4 is a diagram for description of a processing sequence for processes performed by an information processing apparatus according to an embodiment of the present invention.

FIG. 5 is a diagram for description of an example of a configuration of a guide screen displayed in a display unit of an information processing apparatus according to an embodiment of the present invention.

FIG. 6 is a diagram for description of an example of a configuration of a guide screen displayed in a display unit of an information processing apparatus according to an embodiment of the present invention.

FIG. 7 is a diagram for description of an example of a configuration of a guide screen displayed in a display unit of an information processing apparatus according to an embodiment of the present invention.

FIG. 8 is a diagram for description of an example of a configuration of a guide screen displayed in a display unit of an information processing apparatus according to an embodiment of the present invention.

FIG. 9 is a diagram for description of an example of a configuration of a guide screen displayed in a display unit of an information processing apparatus according to an embodiment of the present invention.

FIG. 10 is a diagram for description of an example of a configuration of a guide screen displayed in a display unit of an information processing apparatus according to an embodiment of the present invention.

FIG. 11 is a diagram for description of a processing sequence for processes performed by an information processing apparatus according to an embodiment of the present invention.

FIG. 12 is a diagram for description of an example of a configuration of a guide screen displayed in a display unit of an information processing apparatus according to an embodiment of the present invention.

FIG. 13 is a diagram for description of an example of a configuration of a guide screen displayed in a display unit of an information processing apparatus according to an embodiment of the present invention.

FIG. 14 is a diagram for description of an example of a configuration of a guide screen displayed in a display unit of an information processing apparatus according to an embodiment of the present invention.

FIG. 15 is a diagram for description of an example of a configuration of a guide screen displayed in a display unit of an information processing apparatus according to an embodiment of the present invention.

FIG. 16 is a diagram for description of an example of a configuration of a guide screen displayed in a display unit of an information processing apparatus according to an embodiment of the present invention.

FIG. 17 is a diagram for description of an example of a configuration of a guide screen displayed in a display unit of an information processing apparatus according to an embodiment of the present invention.

FIG. 18 is a diagram for description of an example of a configuration of a guide screen displayed in a display unit of an information processing apparatus according to an embodiment of the present invention.

FIG. 19 is a diagram for description of a processing sequence for processes performed by an information processing apparatus according to an embodiment of the present invention.

FIG. 20 is a diagram for description of a processing sequence for processes performed by an information processing apparatus according to an embodiment of the present invention.

FIG. 21 is a diagram for description of a processing sequence for processes performed by an information processing apparatus according to an embodiment of the present invention.

FIG. 22 is a diagram for description of a processing sequence for processes performed by an information processing apparatus according to an embodiment of the present invention.

FIG. 23 is a diagram for description of a processing sequence for processes performed by an information processing apparatus according to an embodiment of the present invention.

FIG. 24 is a diagram for description of a processing sequence for processes performed by an information processing apparatus according to an embodiment of the present invention.

FIG. 25 is a diagram for description of a processing sequence for processes performed by an information processing apparatus according to an embodiment of the present invention.

FIG. 26 is a block diagram for description of a functional configuration of an information processing apparatus according to an embodiment of the present invention.

FIG. 27 is a diagram for description of an example of a hardware configuration of an imaging apparatus according to an embodiment of the present invention.

### DETAILED DESCRIPTION

Hereinafter, an information processing apparatus, an information processing method, and a computer program according to embodiments of the present invention will be described in detail with reference to the accompanying drawings.

An information processing apparatus according to an embodiment of the invention performs data recording on a disc such as DVD (Digital Versatile Disc) that is used as a recording medium. Hereinafter, an imaging apparatus (camcorder) will be described as an example of the information processing apparatus according to the embodiment of the invention. The present invention is not limited to a camcorder and may be applied to any other apparatus that can record data using a disc as a recording medium. In embodiments to be described below, an exemplary process using a DVD as a recording medium will be described, however, the present invention is not limited to a DVD and may be applied to a configuration in which a plurality of different types of discs other then the DVD are used as recording media.

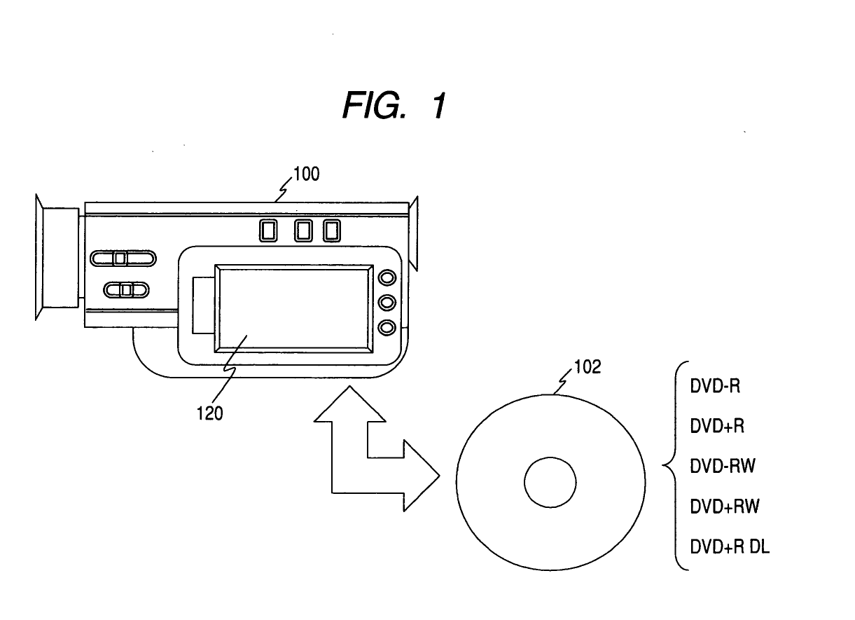

At first, a usage example of a recording medium in the information processing apparatus 100 (imaging apparatus) will be described with reference to FIG. 1. The information processing apparatus 100 can use a disc (DVD) 102 as a recording medium. As types of the DVDs 102 that can be used for the information processing apparatus 100, for example, there are a DVD-R, a DVD+R, a DVD-RW, a DVD+RW, and a DVD+R DL as shown in the figure.

A user is to select one type of disc among the various types of discs. In addition, the user determines an application format after selecting the disc 102 and setting the disc 102 in the information processing apparatus 100 before performing actual data recording and performs data recording in accordance with the determined application format. As application formats, for example, there are a DVD-Video format, a DVD+RW Video Recording format (+VR format), and a DVD Video Recording format (VR format).

These application formats have differences in easiness of editing data recorded on discs and necessity for a finalization process as a process for reproduction of other players, and the like.

In the information processing apparatus 100 according to an embodiment of the invention, guide information is displayed in a display unit (display) 120 of the information processing apparatus 100 for selection of a disc or an application format and a user can easily select an optimal disc or an optimal application format in a wizard mode (interactive mode).

In other words, a guide processing program for selection of a disc format and an application format is recorded in a storage unit of the information processing apparatus 100, and the guide processing program of a wizard mode (interactive mode) is executed under the control of a control unit (CPU) of the information processing apparatus 100.

The guide processing program can be executed at a time when the operation of the information processing apparatus 100 is started by turning the power ON or the like or in accordance with a call on the basis of a user's input at an arbitrary timing. The guide processing program performs different processes depending on the status of the following three types.
(A) a disc is not loaded in the information processing apparatus
(B) a used disc is loaded in the information processing apparatus
(C) an unused disc is loaded in the information processing apparatus (compulsive driving)

In the case of (B) or (C), since a disc is loaded in the information processing apparatus, the information processing apparatus identifies the type of the disc (DVD-R, DVD+R, DVD-RW, DVD+RW, DVD+R DL, or the like) and performs a guide process on the basis of the identified type of the disc.

In a case of (A), since a disc is not loaded in the information processing apparatus, a guide process will be performed also for selection of a disc in accordance with the usage of the disc.

In a case of any one of (A) to (C), the selection of the application format on the basis of the type or usage of the user's data recording is performed by the guide process of a wizard mode (interactive mode).

Before describing a guide processing sequence in detail, the types of discs and the types of application formats will be described. In formats, there are three types of:
(1) physical format (corresponding to the type of disc);
(2) logical format (corresponding to a file system); and
(3) application format (a recording format that a recording application applies).

The logical format corresponds to a file system, and as examples of the logical formats, there are UDF (Universal Disc Format), UDF Ver1.02, and UDF Ver. 2.00. However, the advantage in changing the logical format in accordance with the usage of recording data is not that much, and accordingly, selection of the logical format is not described in embodiments of the invention.

As for the physical format, that is, the disc type, a disc (physical format) to be selected is different on the basis of the usage type of user's recording data such as a usage type for preservation of data and a usage type for allowing a user to erase/rewrite data.

As for the application format, since compatibility with other reproduction apparatuses and easiness of editing differ depending on the application format, it is important to select an appropriate application format on the basis a usage type of recording data.

According to an embodiment of the invention, a process for selecting a disc type (physical format) and an application format that are optimal for the usage of recording data is performed by a guide process of a wizard mode (interactive mode).

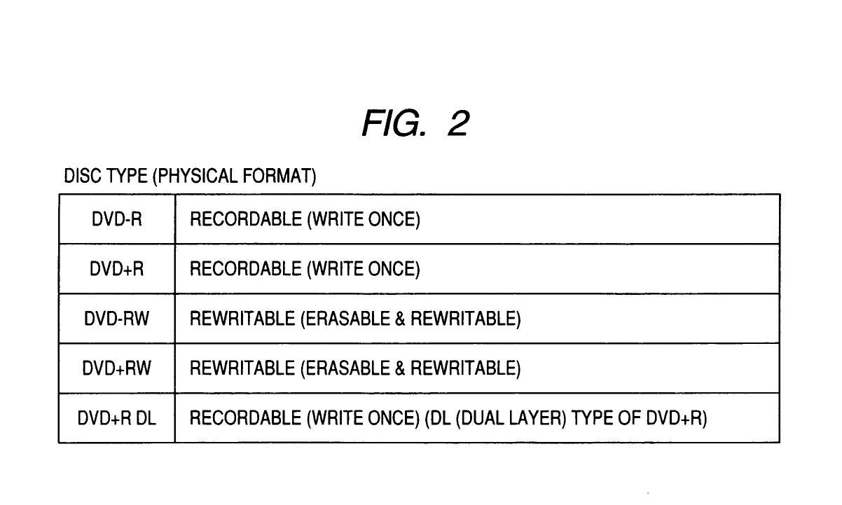

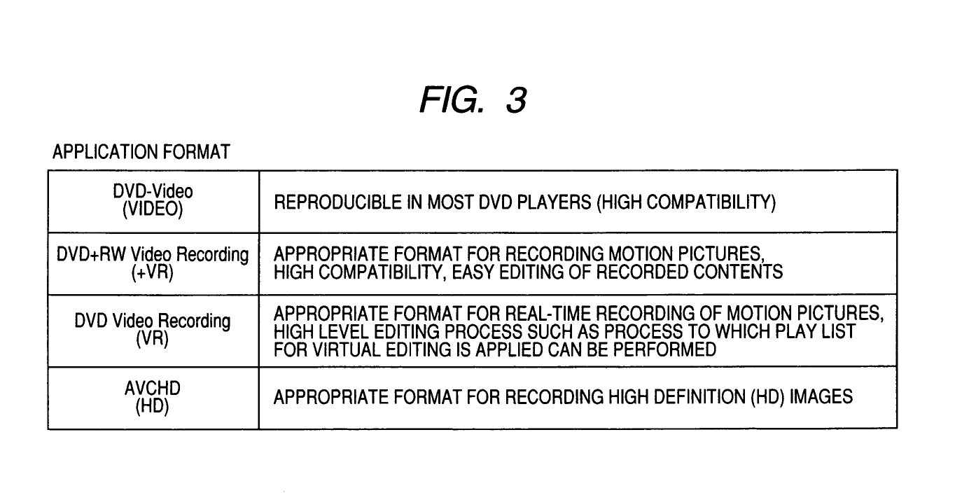

The disc types (physical formats) and the types of application formats will now be described with reference to FIGS. 2 and 3. As shown in FIG. 2, primary disc types (physical formats) and their characteristics are as follows.
DVD-R: recordable (write once)
DVD+R: recordable (write once)
DVD-RW: rewritable (erasable and rewritable)
DVD+RW: rewritable (erasable and rewritable)
DVD+R DL: recordable (write once) (DL (dual layer type of DVD+R))

As shown in FIG. 3, primary types of application formats and their characteristics are as follows.
DVD-Video (abbreviated as VIDEO): reproducible in most DVD players (high compatibility)
DVD+RW Video Recording (abbreviated as +VR): an appropriate format for recording motion pictures, high compatibility, easy editing of recorded contents
DVD Video Recording (abbreviated as VR): an appropriate format for real-time recording of motion pictures, high level editing process such as process to which a play list for virtual editing is applied can be performed
AVCHD (abbreviated as HD): an appropriate format for recording high definition (HD) images

As a primary application formats, there are above-described formats.

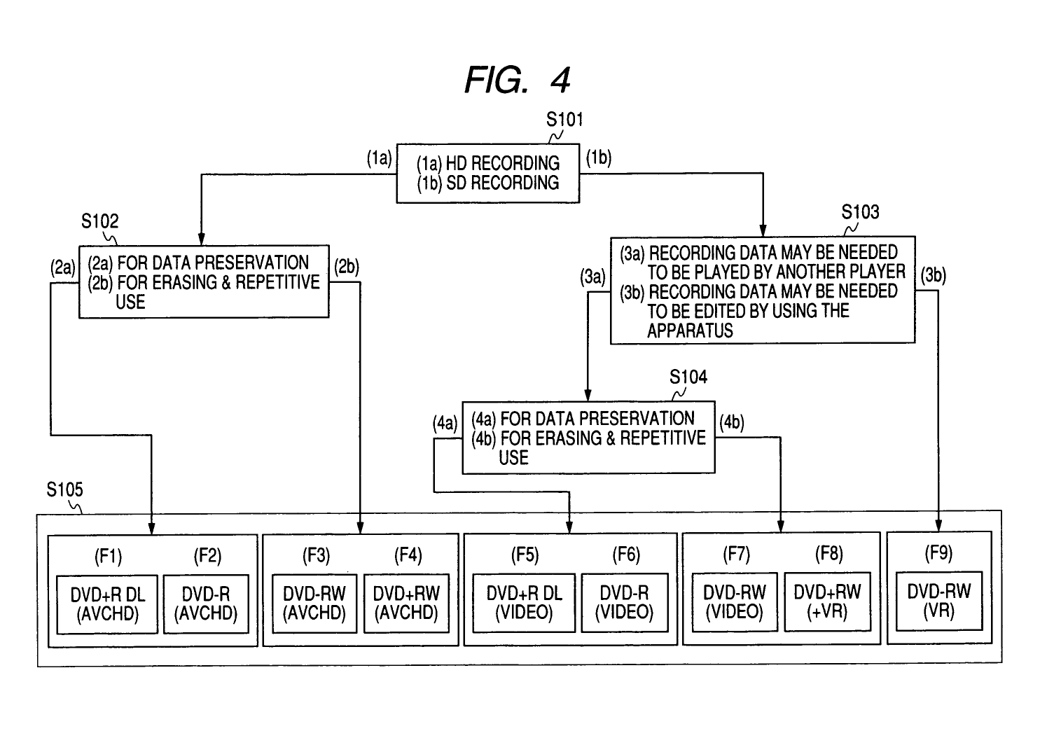

Next, a basic sequence of a guide process that is performed in an information processing apparatus according to an embodiment of the invention, that is, a guiding process for selection of a disc type and an application format in accordance with the type or usage of the user's data recording in a wizard mode (interactive mode) will be described with reference to FIG. 4.

FIG. 4 shows a basic sequence for determining a disc type and an application format that is executed in an information processing apparatus according to an embodiment of the invention. As described above, the guide processing program performs a process that differs in accordance with one of statuses among:
(A) a disc is not loaded in the information processing apparatus;
(B) a used disc is loaded in the information processing apparatus; and
(C) an unused disc is loaded in the information processing apparatus (compulsive driving).

However, basically, the disc type and the application format are determined in accordance with the process sequence shown in FIG. 4.

In the lowest side (step S105) shown in FIG. 4, nine combinations of a disc and an application format of (F1) to (F9) are shown. In (F1) to (F9) of in FIG. 4, disc types (application formats) are shown. In other words, the disc types are as follows.
(F1): DVD+R DL (AVCHD)
(F2): DVD-R (AVCHD)
(F3): DVD-RW (AVCHD)
(F4): DVD+RW (AVCHD)
(F5): DVD+R DL (VIDEO)
(F6): DVD-R (VIDEO)
(F7): DVD-RW (VIDEO)
(F8): DVD+RW (+VR)
(F9): DVD-RW (VR)

In the basic sequence, the above-described nine types of combinations of a disc type and an application format are set, and a final combination among the nine types of combinations is determined. The combinations of the disc type and the application format shown in FIG. 4 are only examples, and different combinations may be set.

The process sequence shown in FIG. 4 will now be described. At first, in a step S101, it is inquired of a user whether
(1a) HD recording as high definition recording is to be performed or
(1b) SD recording as standard definition image quality recording is to be performed.

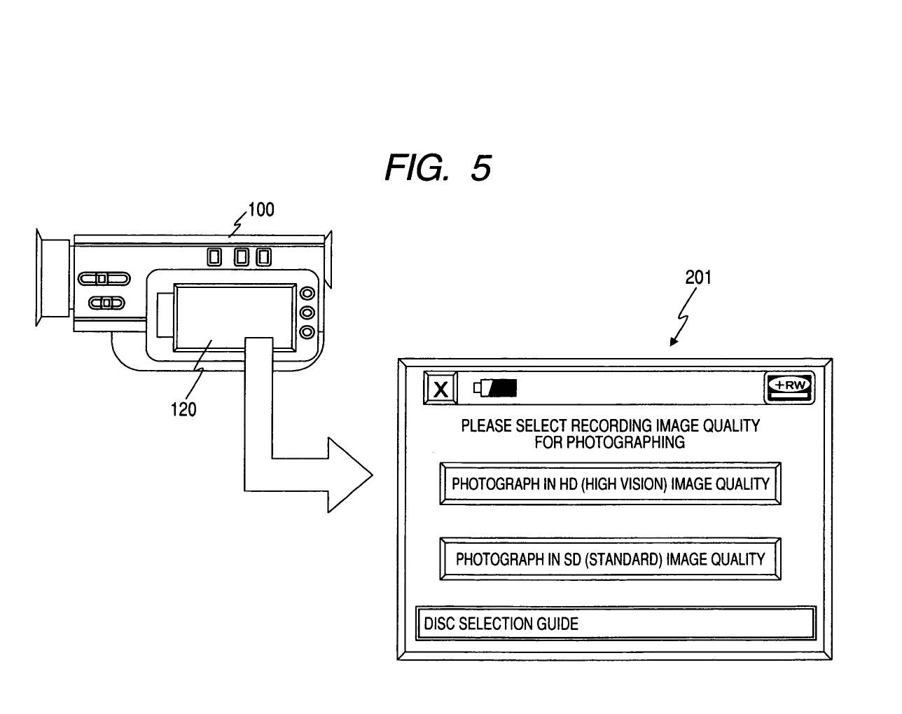

A configuration example for an image quality checking guide screen that is used for the inquiry, that is, an image-quality checking guide screen that checks whether which one between the high definition (HD) recording and the standard (SD) definition recording is desired is shown in FIG. 5. As shown in FIG. 5, in the information processing apparatus according to an embodiment of the invention, a guide screen for selecting a disc or an application format in an wizard mode (interactive mode) is displayed in a display unit (display) 120 of the information processing apparatus 100 and the process proceeds on the basis of a user's response for the guide screen in accordance with the sequence shown in FIG. 4.

The image quality checking guide screen 201 shown in FIG. 5 corresponds to the step S101 shown in FIG. 4.

As options for the inquiry of “PLEASE SELECT RECORDING IMAGE QUALITY FOR PHOTOGRAPHING”, two options of “PHOTOGRAPH IN HD (HIGH VISION) IMAGE QUALITY” and “PHOTOGRAPH IN SD (STANDARD) IMAGE QUALITY” are set, and one between the two options is configured to be selected/input by a user on the screen.

The user selects one between the options in response to the inquiry. The user's input is performed by an operation (touch) of the display unit 120 including a touch panel or an operation of an operation button of the information processing apparatus 100. When the control unit of the information processing apparatus 100 detects the user's input information, the control unit selects a next guide screen on the basis of the user's input and displays the selected guide screen in the display unit 120.

In the example shown in the figure, for example, when “PHOTOGRAPH IN HD (HIGH VISION) IMAGE QUALITY” is selected, the process proceeds to a step S102 shown in a process sequence diagram of FIG. 4. In the step S102, it is inquired of the user whether data recording is for
(2a) data preservation or
(2b) erasing and repetitive use

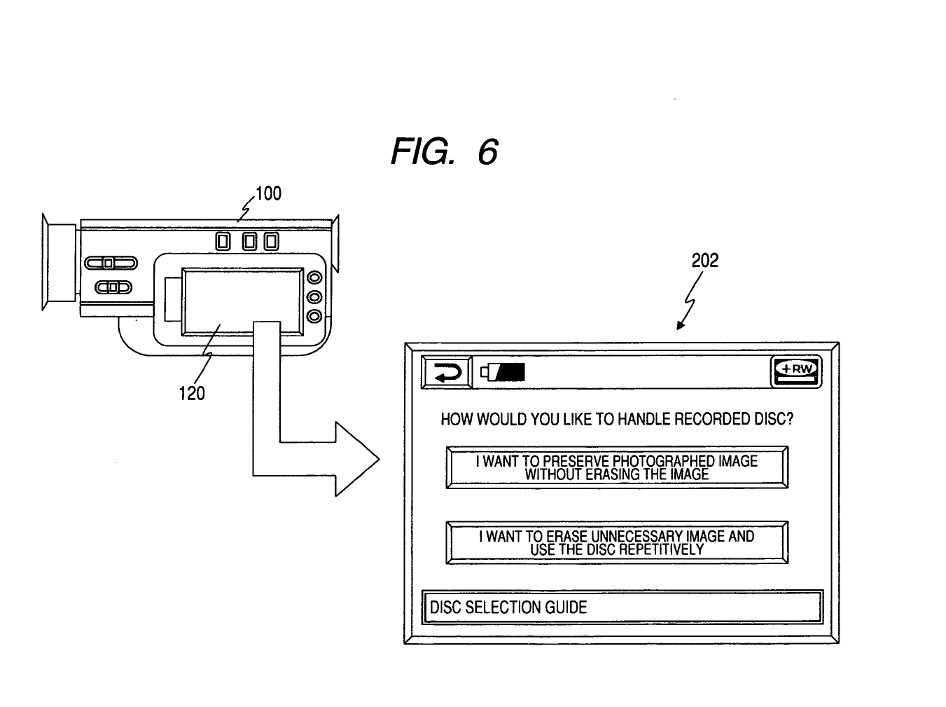

A configuration example of a guide screen that is used for this inquiry, that is, a disc usage type checking guide screen that is used for checking whether the preservation of data recorded on the disc may be needed or erasing the data and reusing the disc may be needed is shown in FIG. 6. The disc usage type checking guide screen 202 shown in FIG. 6 corresponds to the step S102 shown in FIG. 4.

As options for the inquiry of “HOW WOULD YOU LIKE TO HANDLE RECORDED DISC?”, two options of “I WANT TO PRESERVE PHOTOGRAPHED IMAGE WITHOUT ERASING THE IMAGE” and “I WANT TO ERASE UNNECESSARY IMAGE AND USE THE DISC REPETITIVELY” are set, and the disc usage type checking guide screen is configured such that one between the two options is to be selected/input by a user.

The user selects one between the options in response to the inquiry. When the control unit of the information processing apparatus 100 detects the user's input information, the process proceeds to the step S105 shown in the lowest side of FIG. 4, and the control unit selects one of disc types (application formats) shown in the step S105 as a final selection candidate. In this case, when “I WANT TO PRESERVE PHOTOGRAPHED IMAGE WITHOUT ERASING THE IMAGE” is selected, as a final selection candidate, there are selected combinations of:
(F1) DVD+R DL (AVCHD); and
(F2) DVD-R (AVCHD).

On the other hand, when “I WANT TO ERASE UNNECESSARY IMAGE AND USE THE DISC REPETITIVELY” is selected, as final selection candidates, there are selected combinations of:
(F3) DVD-RW (AVCHD); and
(F4) DVD+RW (AVCHD).

The process thereafter differs in accordance with one of statuses of:
(A) a disc is not loaded in the information processing apparatus;
(B) a used disc is loaded in the information processing apparatus; and
(C) an unused disc is loaded in the information processing apparatus (compulsive driving).

This process will be described later.

In the image quality checking guide screen 201 shown in FIG. 5 that is denoted as the step S101 of the process sequence shown in FIG. 4, when “PHOTOGRAPH IN SD (STANDARD) IMAGE QUALITY” is selected, the process proceeds to a step S103 shown in FIG. 4. In the step S103, it is inquired of the user whether:
(3a) RECORDING DATA MAY BE NEEDED TO BE PLAYED BY ANOTHER PLAYER; or
(3b) RECORDING DATA MAY BE NEEDED TO BE EDITED BY USING THE APPARATUS.

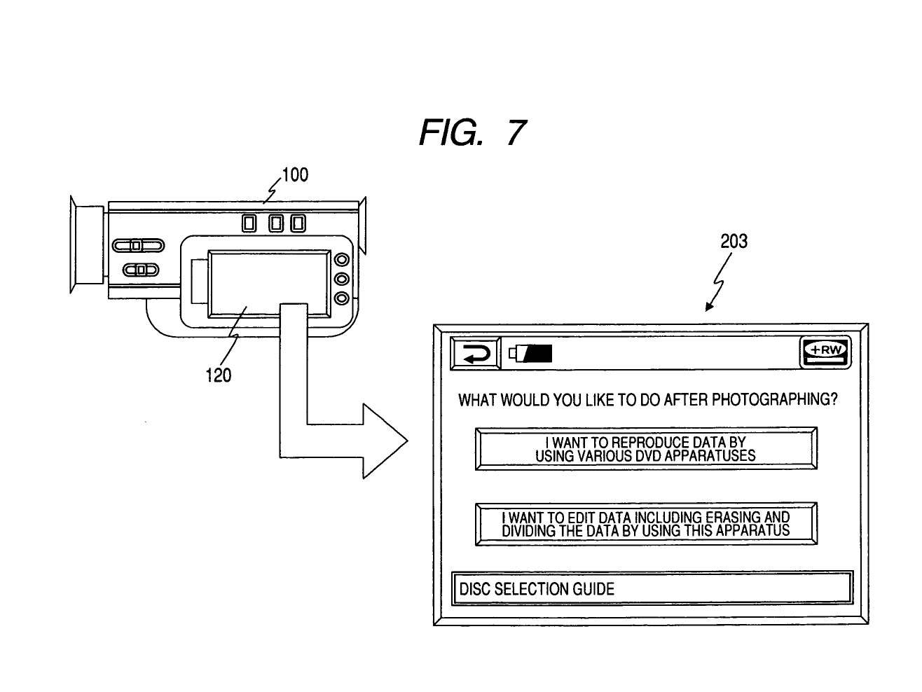

A configuration example for a guide screen that is used for the inquiry, that is, a recording data usage type checking screen checking whether the recording data may be needed to be played by another apparatus or be needed to be edited by using this apparatus is shown in FIG. 7. The recording data usage type checking guide screen 203 shown in FIG. 7 corresponds to the step S103 shown in FIG. 4.

As options for the inquiry of “WHAT WOULD YOU LIKE TO DO AFTER PHOTOGRAPHING?”, two options of “I WANT TO REPRODUCE DATA BY USING VARIOUS APPARATUSES” and “I WANT TO EDIT DATA INCLUDING ERASING AND DIVIDING THE DATA BY USING THIS APPARATUS” are set, and the screen is configured such that one between the two options is selected/input by a user.

The user selects one between the options in response to the inquiry. When the control unit of the information processing apparatus 100 detects the user's input information, the control unit selects a next guide screen on the basis of the user's input and displays the selected guide screen in the display unit 120.

In the example shown in the figure, for example, when “I WANT TO REPRODUCE DATA BY USING VARIOUS DVD APPARATUSES” is selected, the process proceeds to a step S104 shown in a process sequence diagram of FIG. 4. In the step S104, it is inquired of the user whether data recording is
(4a) FOR DATA PRESERVATION or
(4b) FOR ERASING & REPETITIVE USE.

A configuration example of a screen that is used for this inquiry is as shown in FIG. 6 described above. The disc usage type checking guide screen 202 shown in FIG. 6 corresponds to the steps S102 and S104 shown in FIG. 4.

As options for the inquiry of “HOW WOULD YOU LIKE TO HANDLE PHOTOGRAPHED DISC?” two options of “I WANT TO PRESERVE PHOTOGRAPHED IMAGE WITHOUT ERASING THE IMAGE” and “I WANT TO ERASE UNNECESSARY IMAGE AND USE THE DISC REPETITIVELY” are set, and the screen is configured such that one between the two options is to be selected/input by a user.

The user selects one between the options in response to the inquiry. When the control unit of the information processing apparatus 100 detects the user's input information, the process proceeds to the step S105 shown in the lowest side of FIG. 4, and the control unit selects one of disc types (application formats) shown in the lowest side of FIG. 4 as a final selection candidate. In this case, when “I WANT TO PRESERVE PHOTOGRAPHED IMAGE WITHOUT ERASING THE IMAGE” is selected, as final selection candidates, there are selected combinations of:
(F5) DVD+R DL (VIDEO); and
(F6) DVD-R (VIDEO).

On the other hand, when “I WANT TO ERASE UNNECESSARY IMAGE AND USE THE DISC REPETITIVELY” is selected, as final selection candidates, there are selected combinations of:
(F7) DVD-RW (VIDEO); and
(F8) DVD+RW (+VR).

The process thereafter differs in accordance with one of statuses of:
(A) a disc is not loaded in the information processing apparatus;
(B) a used disc is loaded in the information processing apparatus; and
(C) an unused disc is loaded in the information processing apparatus (compulsive driving).

This process will be described later.

In the recording data usage type checking guide screen 203 shown in FIG. 7 that is denoted as the step S103 shown in FIG. 4, when “I WANT TO EDIT DATA INCLUDING ERASING AND DIVIDING THE DATA BY USING THIS APPARATUS” is selected, the process proceeds to a step S105 shown in the lowest side of FIG. 4, and the control unit selects “(F9) DVD-RW (VR)” on the basis of input information as a final selection candidate from combinations of disc types (application formats) shown in the lowest side of FIG. 4.

As described above, the information processing apparatus according to an embodiment of the invention, a question to which a user can easily respond is given and an optimal disc type and an optimal application format can be determined on the basis of input information.

The basic sequence of a determination process of a disc and an application format performed by the information processing apparatus according to an embodiment of the invention is as shown in FIG. 4, and, as described above, an actual process to be performed as the guide process differs in accordance with one of statuses of:
(A) a disc is not loaded in the information processing apparatus;
(B) a used disc is loaded in the information processing apparatus; and
(C) an unused disc is loaded in the information processing apparatus (compulsive driving).

In a case of (B) or (C), since a disc is loaded in the information processing apparatus, the information processing apparatus identifies the type of the disc and performs a guide process on the basis of the determined type of disc. In a case of (A), since a disc is not loaded in the information processing apparatus, a guide process will be performed also for selection of a disc in accordance with the usage of the disc. Hereinafter, process sequences on the basis of the statuses of (A) to (C) will be described one by one.

(A) Process for Case where Disc is Not Loaded in Information Processing Apparatus

At first, a process for a case where a disc is not loaded in the information processing apparatus will be described. When a disc is not loaded in the information processing apparatus, the process described with reference to FIG. 4 is performed, and the user is informed that any one or a plurality of sets among the disc types (application formats) of (F1) to (F9) shown in FIG. 4 can be used.

In other words, after the process described with reference to FIGS. 4 to 7 is performed, the process proceeds to the step S105 in the lowest side shown in FIG. 4, and the user is informed that any one or a plurality of sets among the disc types (application formats) of (F1) to (F9) shown in FIG. 4 can be used.

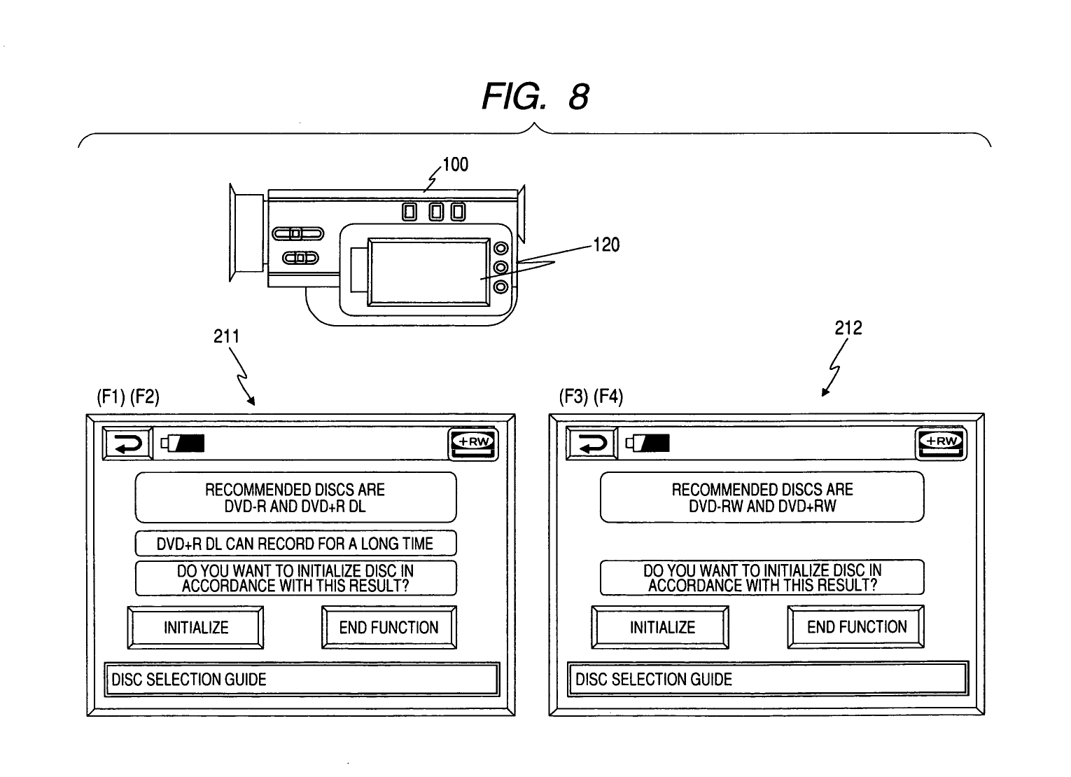

For example, the guide screens shown in FIGS. 8 to 10 are displayed in the display unit 120 of information processing apparatus 100. The guide screen 211 shown in FIG. 8 is displayed when (F1) and (F2) are selected in the process step S105 shown in FIG. 4.

In the guide screen 211, as description for the determined disc types, disc type description of “RECOMMENDED DISCS ARE DVD-R AND DVD+R DL” is displayed, and as hint information on which one between the two types of disc types is preferable, hint information of “DVD+R DL CAN RECORD FOR A LONG TIME” is displayed additionally.

As an inquiry of the user, an inquiry of “DO YOU WANT TO INITIALIZE DISC IN ACCORDANCE WITH THIS RESULT?” is displayed, and the screen is configured such that, as options thereof, there can be selected one between two options of:
“INITIALIZE”; and
“END FUNCTION”.

The user selects one between the two options. When the control unit of the information processing apparatus 100 detects user's input information, the control unit performs a process on the basis of the user's input. When “END FUNCTION” is selected, the control unit ends the guide processing program. On the other hand, when “INITIALIZE” is selected, a next guide screen is selected and id displayed in the display unit 120. This process will be described later.

The other guide screen 212 shown in FIG. 8 is displayed when (F3) and (F4) are selected in the process step S105 shown in FIG. 4.

In the guide screen 211, as description for the determined disc types, disc type description of “RECOMMENDED DISCS ARE DVD-RW AND DVD+RW” is displayed. In addition, as an inquiry of the user, an inquiry of “DO YOU WANT TO INITIALIZE DISC IN ACCORDANCE WITH THIS RESULT?” is displayed, and the screen is configured such that, as options thereof, there can be selected one between two options of:
“INITIALIZE”; and
“END FUNCTION”.

The user selects one between the two options.

As described above with reference to FIG. 4, although application formats along with disc types are determined in the settings of (F1) to (F9), information on the application format is not configured to be provided in the guide screen displayed to the user. However, a configuration in which description for the used application formats is displayed may be used.

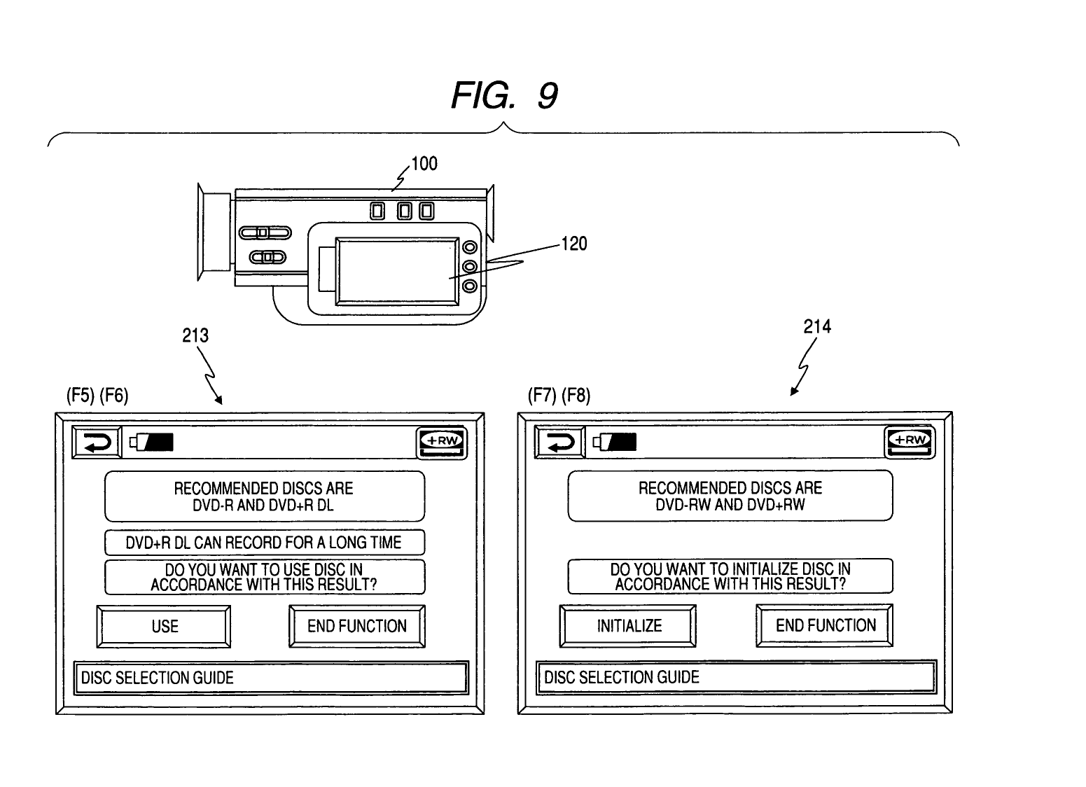

A guide screen 213 shown in FIG. 9 is displayed when (F5) and (F6) are selected in the step S105 shown in FIG. 4.

In the guide screen 213, as description for the determined disc types, disc type description of “RECOMMENDED DISCS ARE DVD-R AND DVD+R DL” is displayed, and as hint information on which one between the two types of disc types is preferable, hint information of “DVD+R DL CAN RECORD FOR A LONG TIME” is displayed additionally.

As an inquiry of the user, an inquiry of “DO YOU WANT TO USE DISC IN ACCORDANCE WITH THIS RESULT?” is displayed, and the screen is configured such that, as options thereof, there can be selected one between two options of:
“USE”; and
“END FUNCTION”.

The user selects one between the two options. The case where (F5) and (F6) are selected in the step S105 shown in FIG. 4 is when the DVD-R and DVD+R DL are used in a standard definition (SD) image recording, and as the application format, the DVD-Video (VIDEO) format is selected. In this case, since the initialization process can be performed in accordance with data recording timing, the initialization process at this moment is not needed. Accordingly, an inquiry whether the disc is used is configured to be given.

The other guide screen 214 shown in FIG. 9 is displayed when (F7) and (F8) are selected in the process step S105 shown in FIG. 4.

In the guide screen 214, as description for the determined disc types, disc type description of “RECOMMENDED DISCS ARE DVD-RW AND DVD+RW” is displayed. In addition, as an inquiry of the user, an inquiry of “DO YOU WANT TO INITIALIZE DISC IN ACCORDANCE WITH THIS RESULT?” is displayed, and the screen is configured such that, as options thereof, there can be selected one between two options of:
“INITIALIZE”; and
“END FUNCTION”.

The user selects one between the two options.

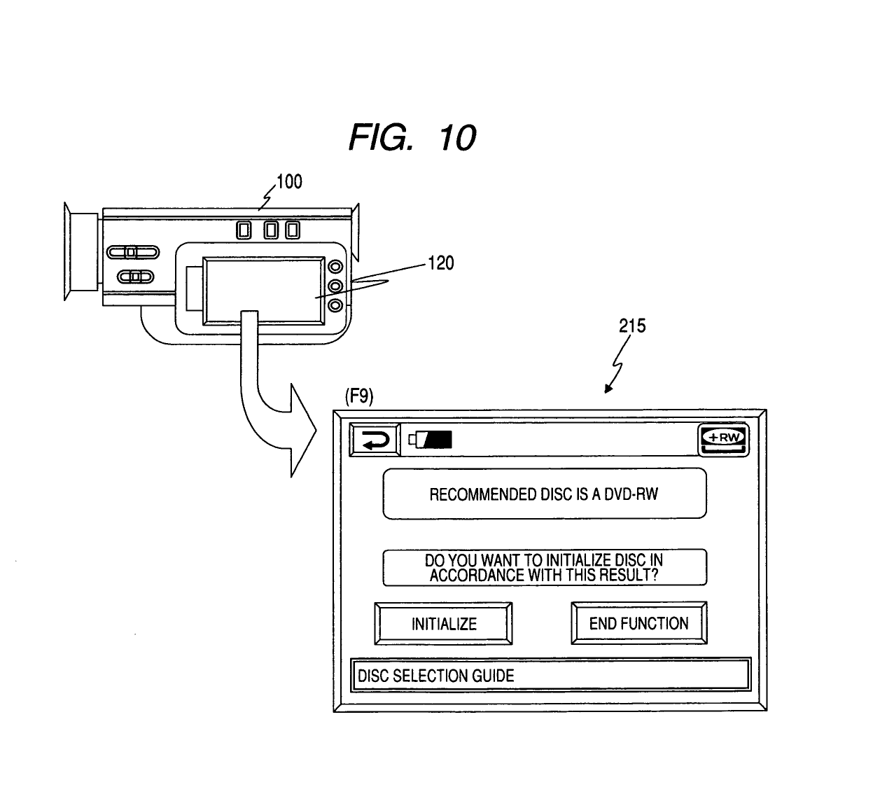

A guide screen 215 shown in FIG. 10 is displayed when (F9) is selected in the process step S105 shown in FIG. 4.

In the guide screen 215, as description for the determined disc type, disc type description of “RECOMMENDED DISCS IS A DVD-RW” is displayed. In addition, as an inquiry of the user, an inquiry of “DO YOU WANT TO INITIALIZE DISC IN ACCORDANCE WITH THIS RESULT?” is displayed, and the screen is configured such that, as options thereof, there can be selected one between two options of:
“INITIALIZE”; and
“END FUNCTION”.

The user selects one between the two options.

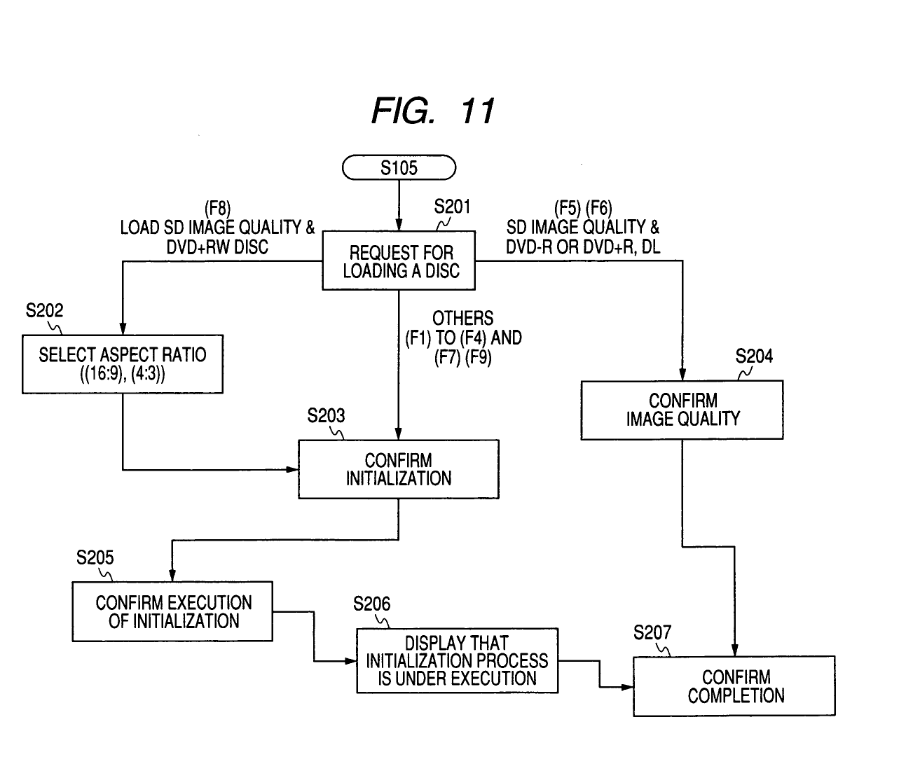

Next, in the guide process in a case where a disc is not loaded, there will be described with reference to FIG. 11 and figures thereafter about a process performed in a case where the user selects “INITIALIZE” in response to display of the guide screens 211 to 215, which have been described with reference to FIGS. 8 to 10, in the display unit 120 of the information processing apparatus 100 in the step S105 shown in FIG. 4.

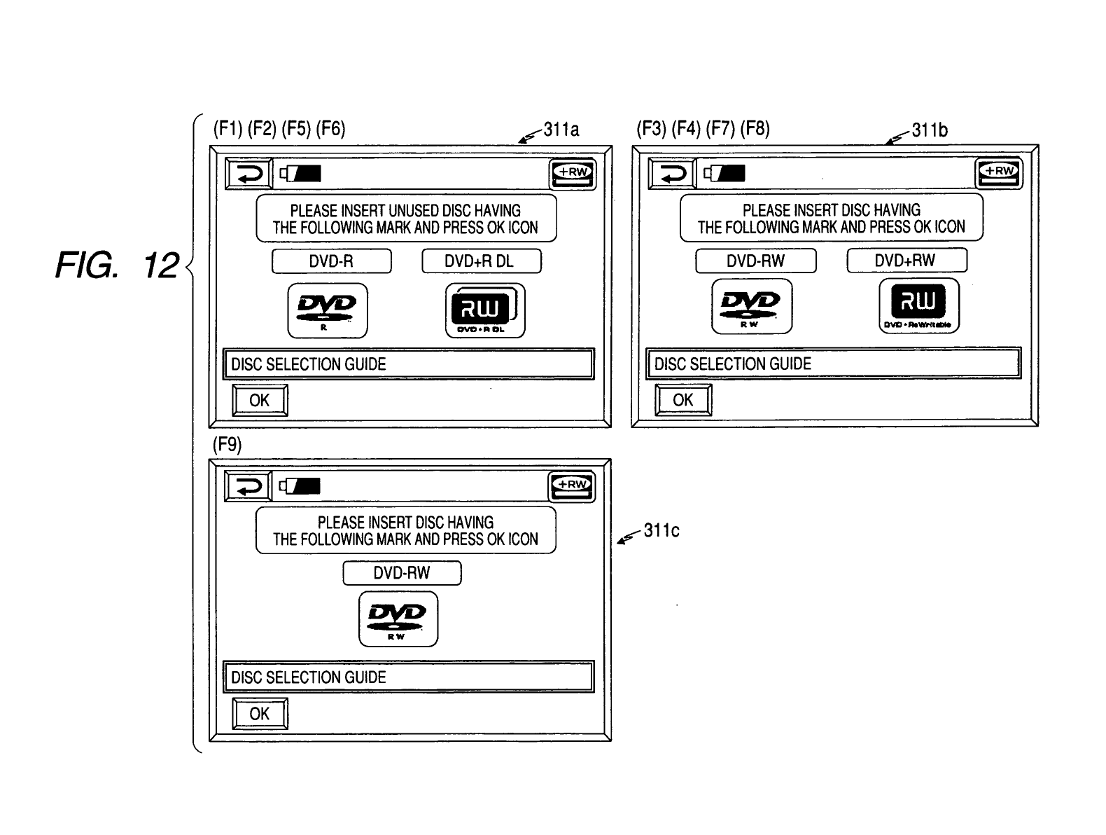

A step S201 shown in FIG. 11 is performed when a disc is not loaded and the user selects “INITIALIZE” in response to the guide screens 211 to 215, which have been described with reference to FIGS. 8 to 10, displayed in the display unit 120 of the information processing apparatus 100 in the step S105 shown in FIG. 4. In the step S201, a request for loading a disc is performed. At this time, the guide screen shown in FIG. 12 is displayed in the display unit 120 of the information processing apparatus 100.

A disc loading request screen 311a shown in FIG. 12 is displayed when the combination of a disc and an application format that is determined in the step S105 of the sequence shown in FIG. 4 is:
(F1) DVD+R DL (AVCHD);
(F2) DVD-R (AVCHD);
(F5) DVD+R DL (VIDEO); or
(F6) DVD-R (VIDEO).

A disc loading request screen 311b is displayed when the combination of a disc and an application format that is determined in the step S105 of the sequence shown in FIG. 4 is:
(F3) DVD-RW (AVCHD);
(F4) DVD+RW (AVCHD);
(F7) DVD-RW (VIDEO); or
(F8) DVD+RW (+VR).

A disc loading request screen 311c is displayed when the combination of a disc and an application format that is determined in the step S105 of the sequence shown in FIG. 4 is “(F9) DVD-RW (VR)”.

Each of the disc loading request screens includes a screen requiring for loading of the determined disc. In the disc loading request screens, corresponding names such as DVD-R, DVD+R, DVD-RW, DVD+RW, and DVD+R DL as disc types (physical formats) and logos as identification marks which are respectively set corresponding to the disc types are displayed. Since logos are basically written on discs in the market, the user can select a disc having a same logo as the logo displayed in the disc loading request screen by comparing them.

When the user loads a designated disc in the information processing apparatus and operates an OK icon that is displayed in each of the disc loading request screens 311a to 311c, the process proceeds to one of steps S202 to S204 in a sequence diagram shown in FIG. 11.

To which step among the steps S202 to S204 the process proceeds is determined on the combination of the disc and the application format.

The process proceeds to the step S202 in a case of “(F8) DVD+RW (+VR)”.

That is, a case where the SD image quality recording is selected and the loaded disc is DVD+RW. In this case, the application format becomes DVD+RW Video (+VR) and selection of the aspect ratio of a recording moving picture may be required in the step S202.

The process proceeds to the step S204 in cases of:
(F5) DVD+R DL (VIDEO); and
(F6) DVD-R (VIDEO).

That is, a case where the SD image quality recording is selected and the loaded disc is a DVD+R DL or a DVD-R. In this case, as described above with reference to the guide screen 213 shown in FIG. 9, since an initialization process is not required in advance, the process sequence is different from those of other cases.

The process proceeds to the step S203 in other cases of:
(F1) DVD+R DL (AVCHD);
(F2) DVD-R (AVCHD);
(F3) DVD-RW (AVCHD);
(F4) DVD+RW (AVCHD);
(F7) DVD-RW (VIDEO); and
(F9) DVD-RW (VR).

In these cases, the aspect ratio is not set and an initialization process is performed.

At first, the process in the step S202 will be described. The process proceeds to the step S202 in a case of “(F8) DVD+RW (+VR)”, that is, a case where the SD image quality recording is selected and the loaded disc is DVD+RW. In this case, selection of the aspect ratio of a motion picture to be recorded is requested to the user in the step S202.

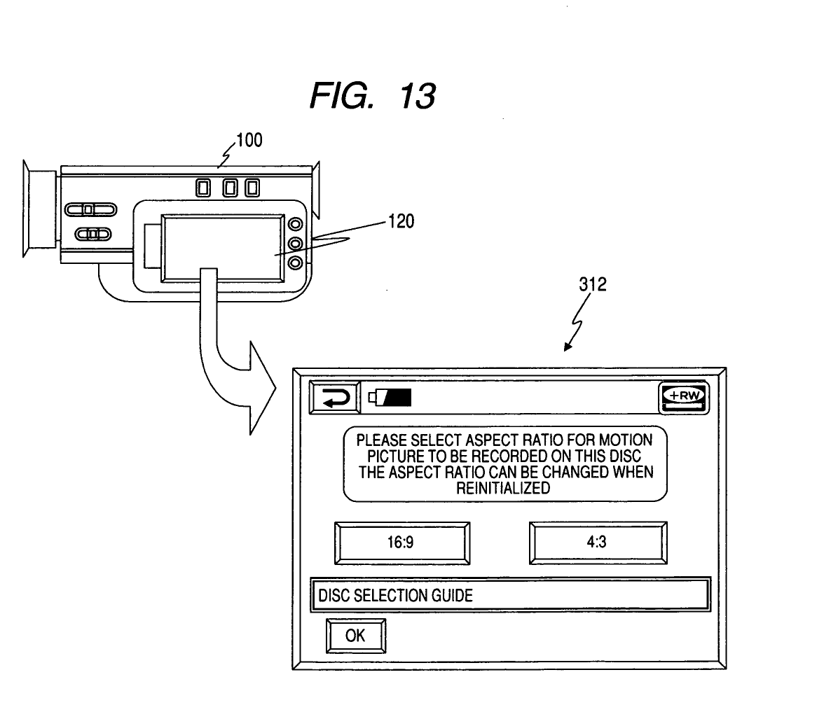

In the step S202, an example of a guide screen displayed in the display unit 120 of the information processing apparatus 100 is shown in FIG. 13. As shown in FIG. 13, a request of “PLEASE SELECT ASPECT RATIO FOR MOTION PICTURE TO BE RECORDED ON THIS DISC. THE ASPECT RATIO CAN BE CHANGED WHEN REINITIALIZED” appears in the aspect ratio selection requesting guide screen 312, and as options, two options of: “16:9” and “4:3” are displayed, and the user selects any one between the options. When the control unit of the information processing apparatus detects a response to the request, the process proceeds to the step S203 of the sequence diagram shown in FIG. 11.

A process in the step S203 of the sequence diagram shown in FIG. 11 will now be described. The step S203 is for confirming an initialization process. The step S203 is performed in a case of “(F8) DVD+RW (+VR)” after the above-described step S202 for selecting the aspect ratio and cases of:
(F1) DVD+R DL (AVCHD);
(F2) DVD-R (AVCHD);
(F3) DVD-RW (AVCHD);
(F4) DVD+RW (AVCHD);
(F7) DVD-RW (VIDEO); and
(F9) DVD-RW (VR).

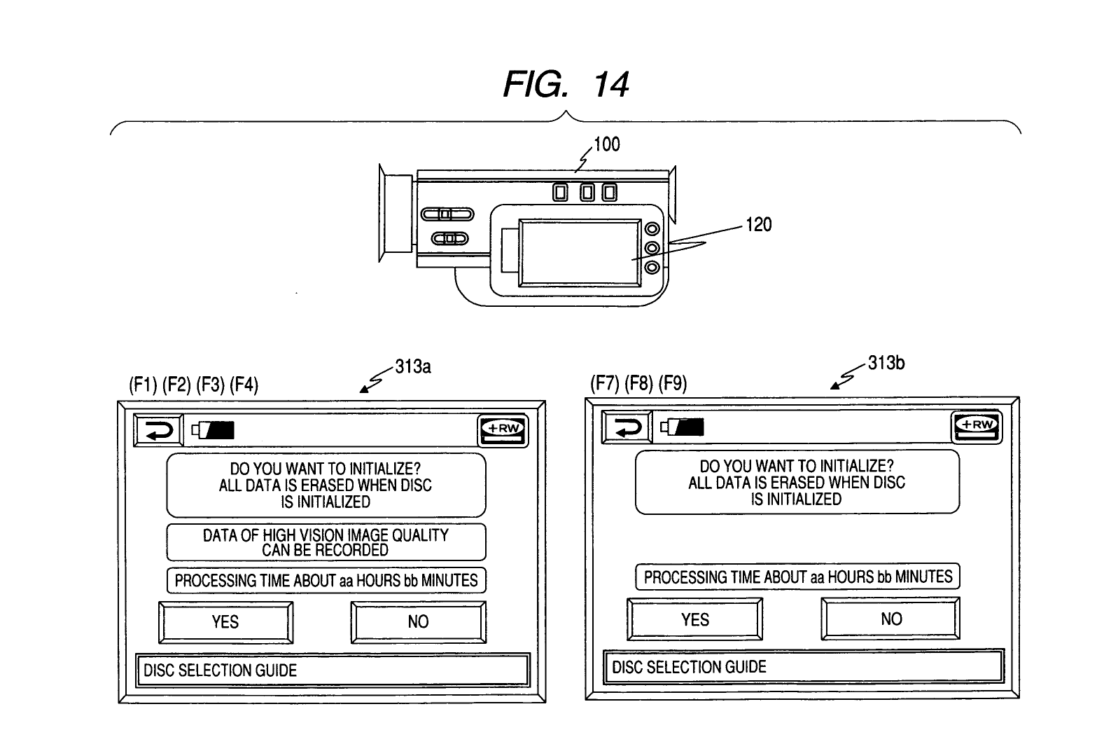

In the step S203, an example of guide screens displayed in the display unit 120 of the information processing apparatus 100 is shown in FIG. 14. As shown in FIG. 14, in the step S203, initialization process confirming guide screen 313a or 313b are displayed in the step S203. In FIG. 14, two type of the initialization process confirming guide screen 313a or 313b are shown.

The initialization process confirming guide screen 313a is displayed when the user select high definition (HD) recording, that is, the setting is for:
(F1) DVD+R DL (AVCHD);
(F2) DVD-R (AVCHD);
(F3) DVD-RW (AVCHD); or
(F4) DVD+RW (AVCHD).

In the initialization process confirming guide screen 313a, it is displayed that image recording corresponding to high vision can be performed.

The initialization process confirming guide screen 313b is displayed when the user select standard definition (SD) recording, that is, the setting is for:
(F7) DVD-RW (VIDEO);
(F8) DVD+RW (+VR); or
(F9) DVD-RW (VR).

In the initialization process confirming guide screen 313b, it is not displayed that image recording corresponding to high vision can be performed.

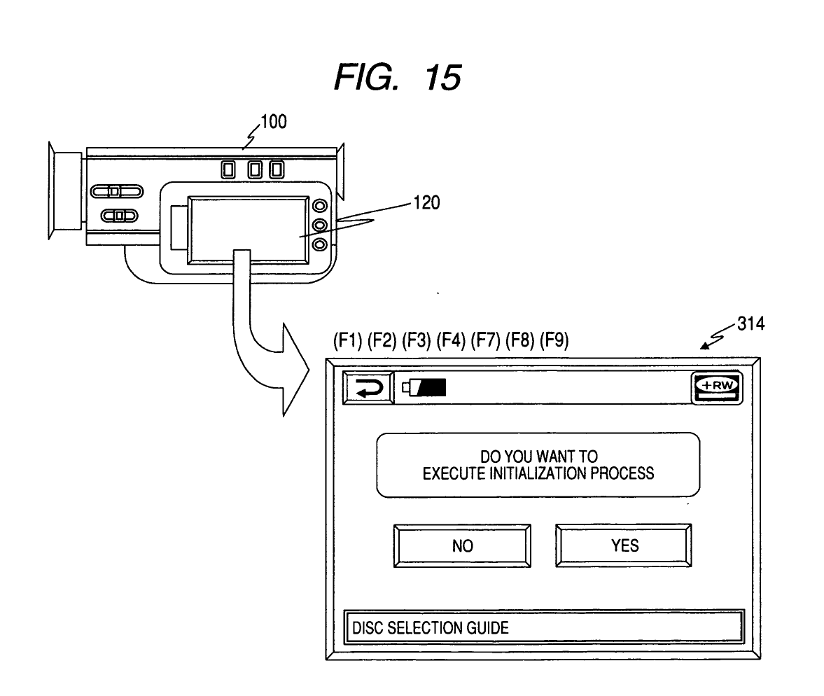

In both the initialization process confirming guide screens 313a and 313b, a processing time that may be required for the initialization process is displayed, whereby the user can notice the required time for the initialization process. When the user select “Yes” in the initialization process confirming guide screens 313a and 313b, the control unit detect the input selection information, and the process proceeds to the next step S205 to be processed. The step S205 is for a process for reconfirming the user that the initialization process may be actually performed. When the initialization process is performed, all recorded data is erased, and thus, the performance of the initialization process is reconfirmed. An example of the guide screen displayed at this time in the display unit 120 of the information processing apparatus 100 is shown in FIG. 15. As shown in FIG. 15, in the step S205, a confirming guide screen 314 that allows the user to input one of “YES” and “NO” for reconfirming that the initialization process may be performed is displayed.

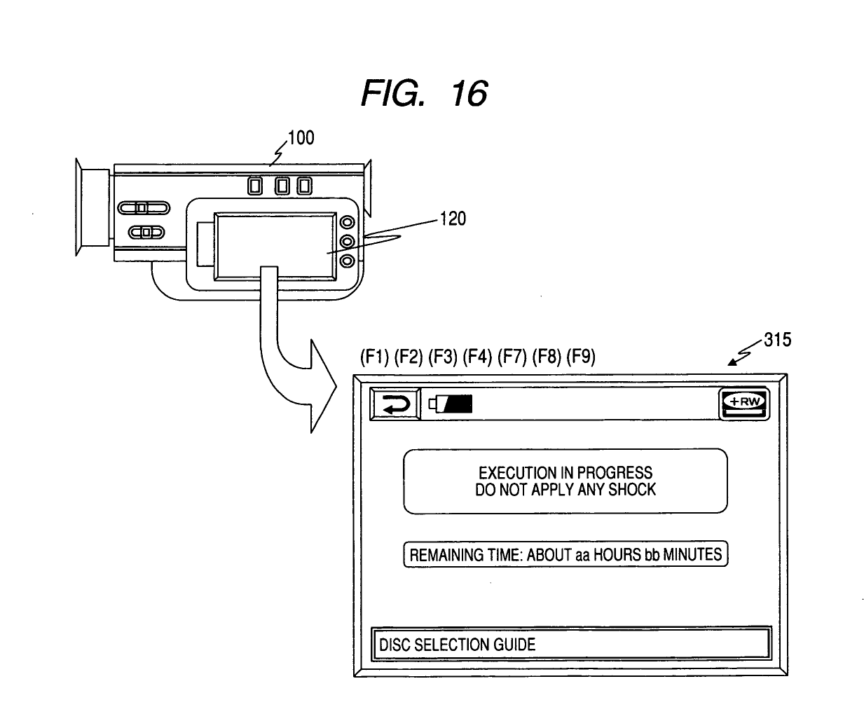

When the user input “YES” in the confirming guide screen 314, the control unit detects the input information, and the process proceeds to the next step S206. The step S206 is for performing the initialization process. In the initialization process performing step, a guide screen indicating the initialization process is under execution is displayed in the display unit 120 of the information processing apparatus 100. An example of the guide screen is shown in FIG. 16.

In the step S206, as shown in FIG. 16, a guide screen 315 indicating the initialization process is under execution is displayed. In the guide screen 315, an attention message of “EXECUTION OF INITIALIZATION PROCESS IN PROGRESS. DO NOT APPLY ANY SHOCK” is displayed, and a remaining time for the initialization process is also displayed, whereby the user can notice the approximate time for completing the initialization process.

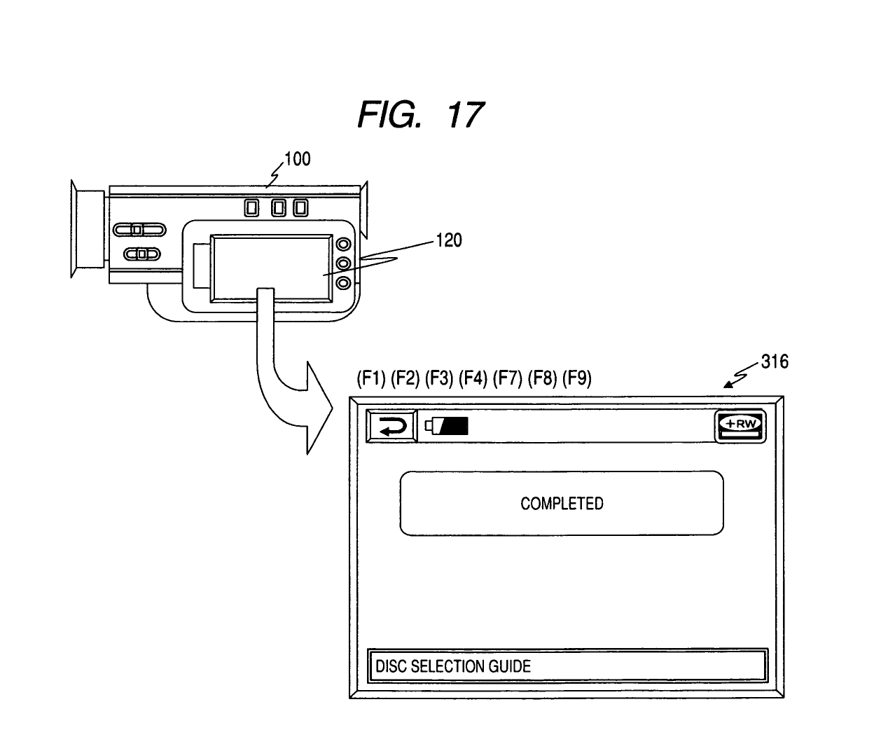

When the initialization process is completed, the process proceeds to a step S207. In the step S207, a completion confirming screen that indicates that the process is completed is displayed in the display unit 120 of the information processing apparatus 100. An example of the completion confirming screen is shown in FIG. 17. As shown in FIG. 17, in the completion confirming screen 316, a message indicating that the process is completed is displayed. After checking this completion confirming screen, the user starts a recording process such as a photographing process.

The step S204 of the sequence diagram shown in FIG. 1, as described above, is performed for cases of:
(F5) DVD+R DL (VIDEO); and
(F6) DVD-R (VIDEO).

In other words, the step S204 is performed for a case where the SD image recording is selected and the loaded disc is DVD+R DL or DVD-R. In this case, as described above with reference to the guide screen 213 shown in of FIG. 9, since the previous initialization process is not required, a process different from other processes is configured.

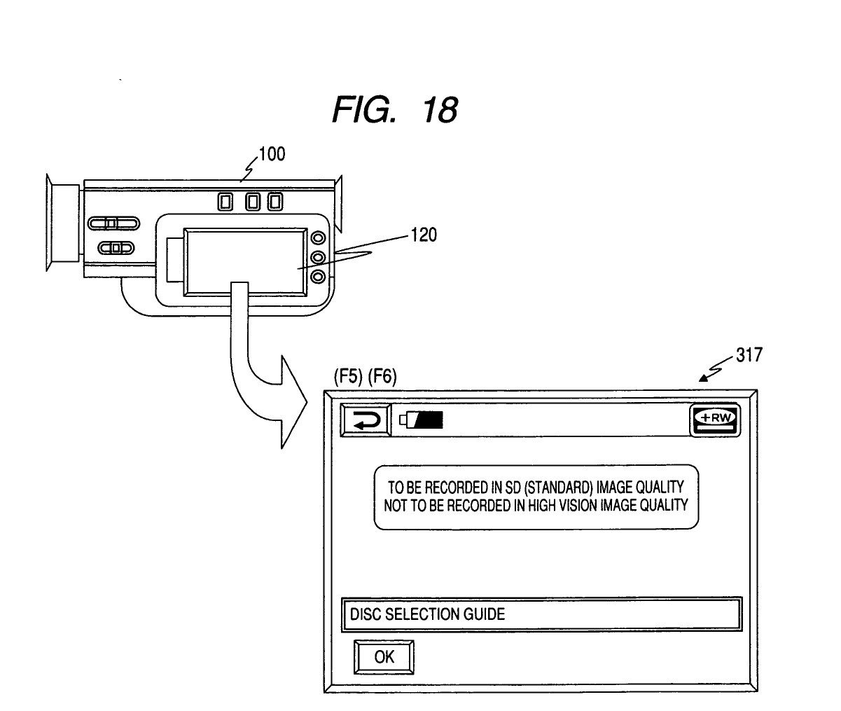

In this case, in the step S204, a guide screen for confirming that the recording image quality is standard definition (SD) is displayed in the display unit 120 of the information processing apparatus 100. An example of this guide screen is shown in FIG. 18. As shown in FIG. 18, in the image quality confirming guide screen 317, an attention message of “RECORDED IN SD (STANDARD) IMAGE QUALITY. NOT RECORDED IN HIGH VISION IMAGE QUALITY” is displayed.

After checking this message, the user operates an OK icon. When the operation information is input to the control unit, the process proceeds to a step S207. Then, a message indicating the completion of the process is displayed in the completion confirming screen 317 that has been described above with reference to FIG. 17. After checking this screen, the user starts a data recording process such as a photographing process.

The process described above is the guide process performed in a case where “(A) Disc Is Not Loaded In The Information Processing Apparatus”.

In other words, the whole sequence for a case where a disc is not loaded in the information processing apparatus is a process that combines the process sequences shown in FIGS. 4 and 11. As can be understood from the processes, the user can select an optimal disc and an optimal application format in accordance with the usage type of the disc by only sequentially responding to inquiries displayed in the display unit of the information processing apparatus 100, and processes that may be required after the selection can be performed assuredly, whereby a data recording operation in which the optical application format is used for the optical disc can be started smoothly.

(B) For Case where Disc is Loaded in Information Processing Apparatus

Next, a process for a case where a disc is loaded in the information processing apparatus will be described. As described above, in the case of “(B)”, since a disc is loaded in the information processing apparatus, the information processing apparatus identifies the type of the disc (DVD-R, DVD+R, DVD-RW, DVD+RW, DVD+R DL, or the like) and performs a guide process on the basis of the identified type of disc.

In the process of (B), a combination of a disc type and an application format is basically determined in accordance with the sequence diagram shown in FIG. 4. However, since a disc is already loaded in the information processing apparatus, only guide processes corresponding to the loaded disc type are performed. Accordingly, process sequences differ for each loaded disc type. Hereinafter, there will be described one by one for process sequences on the basis of the statuses of:
(B1) a case where a DVD-R or a DVD+R DL is loaded;
(B2) a case where a DVD-RW is loaded; and
(B3) a case where a DVD+RW is loaded.
(B1) A case Where DVD-R or DVD+R DL Is Loaded

At first, a guide process in a case where a DVD-R or a DVD+R DL is loaded in the information processing apparatus will be described.

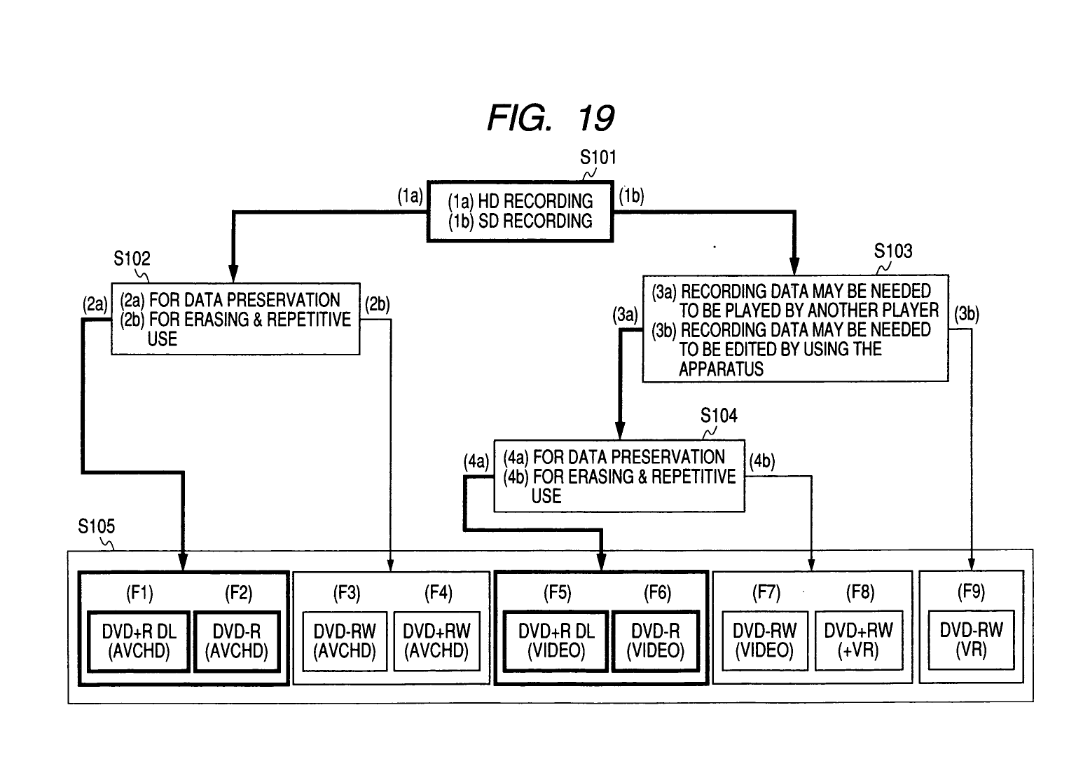

In FIG. 19, a sequence diagram as is described with reference to FIG. 4 is shown. As is understood from FIG. 19, when a DVD-R or a DVD+RDL is loaded in the information processing apparatus, a combination of a disc type and an application format that is recommended in the information processing apparatus according to an embodiment of the invention is one among:
(F1) DVD+R DL (AVCHD);
(F2) DVD-R (AVCHD);
(F5) DVD+R DL (VIDEO); and
(F6) DVD-R (VIDEO).

In a sequence diagram shown in FIG. 19, a step that determines the difference between a set of (F1) and (F2) and a set of (F5) and (F6) is the only determination step S101 for determining whether data recording is HD recording or SD recording. Other determination steps S102 to S104 are unnecessary when the type of the disc loaded in the information processing apparatus is DVD-R or DVD+R DL.

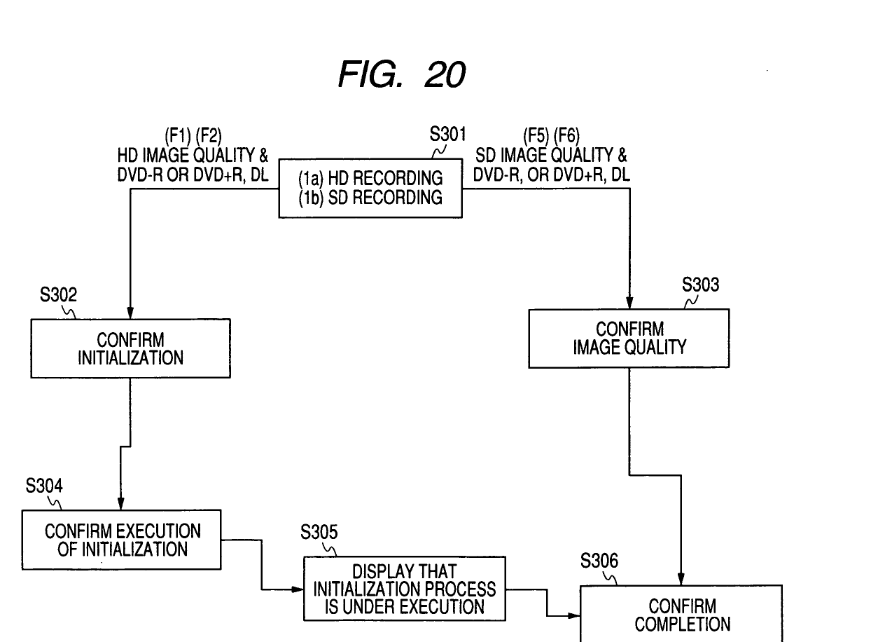

Thus, after one set between the set of (F1) and (F2) and the set of (F5) and (F6) to be used is determined by performing the determination process of the step S101, a same process as the process flow shown in FIG. 11 described above is performed. As a result, the guide process is performed in accordance with a sequence shown in FIG. 20.

Each step of the sequence shown in FIG. 20 will now be described. The process shown in FIG. 20 is performed after a disc is loaded in the information processing apparatus and a process for identifying whether the loaded disc is DVD-R or DVD+R DL is performed. In the information processing apparatus, a guide screen in a wizard mode (interactive mode) is displayed in the display unit (display) 120 of the information processing apparatus 100, and the process proceeds in accordance with a user's input as a response.

At first, in a step S301, it is inquired of the user whether:
(1a) HD recording as high definition recording is performed; or
(1b) SD recording as standard definition image quality recording is performed.

The configuration of a screen that is used for this inquiry is the image quality checking guide screen 201 described above with reference to FIG. 5. In the image quality checking guide screen 201 shown in FIG. 5 is, as described above, as options for the inquiry of “PLEASE SELECT RECORDING IMAGE QUALITY FOR PHOTOGRAPHING”, two options of “PHOTOGRAPH IN HD (HIGH VISION) IMAGE QUALITY” and “PHOTOGRAPH IN SD (STANDARD) IMAGE QUALITY” are set, and one between the two options is configured to be selected/input by a user.

The user selects one between the options in response to the inquiry. When the control unit of the information processing apparatus 100 detects the user input information, the control unit determines on the basis of the input which one to select among:
(F1) DVD+R DL (AVCHD);
(F2) DVD-R (AVCHD);
(F5) DVD+R DL (VIDEO); and
(F6) DVD-R (VIDEO).

For example, when the user selects “PHOTOGRAPH IN HD (HIGH VISION) IMAGE QUALITY”, there is set one between:
(F1) DVD+R DL (AVCHD); and
(F2) DVD-R (AVCHD).

One setting between (F1) and (F2) is determined depending on the disc type that is identified after being loaded in the information processing apparatus.

On the other hand, when the user selects “PHOTOGRAPH IN SD (STANDARD) IMAGE QUALITY”, there is set one between:
(F5) DVD+R DL (VIDEO); and
(F6) DVD-R (VIDEO).

One setting between (F5) and (F6) is determined depending on the disc type that is identified after being loaded in the information processing apparatus.

After the determination process, the control unit selects a next guide screen and displays the selected guide screen in the display unit 120. For example, when the user selects “PHOTOGRAPH IN HD (HIGH VISION) IMAGE QUALITY”, the process proceeds to a step S302 in the sequence diagram shown in FIG. 20.

The processes for the step S302 and steps S304 to S306 correspond to the steps S203 and S205 to S207 which have been described with reference to FIG. 11. At first, in the step S302, a confirming process of the initialization process is performed. A guide screen displayed in the display unit 120 of the information processing apparatus 100 in the step S302 is the guide screen 313a that has been described above with reference to FIG. 14.

In this example of the process, when the user selects high definition (HD) recording, since the setting is “(F1) DVD+R DL (AVCHD)” or “(F2) DVD-R (AVCHD)”, the guide screen 313a in which “image recording corresponding to high vision can be performed” is indicated is displayed.

Since a processing time that may be required for the initialization process is displayed in the guide screen, the user can notice the required time. When the user select “YES” in the initialization process confirming guide screen 313a, the control unit detects the selection input information, and the process proceeds to the next step S304 to be processed.

The step S304 is for a process for reconfirming the user that the initialization process may be actually performed. When the initialization process is performed, all recorded data is erased, and thus, the performance of the initialization process is reconfirmed. At this time, a guide screen displayed in the display unit 120 of the information processing apparatus 100 is the confirming guide screen 314 described above with reference to FIG. 15. In the step S304, a confirming guide screen 314 shown in FIG. 15 that allows the user to input one between “YES” and “NO” for reconfirming that the initialization process may be performed is displayed.

When the user input “YES” in the confirming guide screen 314, the control unit detects the input information, and the process proceeds to the next step S305. The step S305 is for performing the initialization process. In the initialization process performing step, a guide screen indicating the initialization process is under execution is displayed in the display unit 120 of the information processing apparatus 100. An example of the guide screen is the guide screen 315 described above with reference to FIG. 16.

In the step S305, as shown in FIG. 16, a guide screen 315 indicating the initialization process is under execution is displayed. In the guide screen 315, an attention message of “EXECUTION OF INITIALIZATION PROCESS IN PROGRESS. DO NOT APPLY ANY SHOCK” is displayed, and a remaining time for the initialization process is also displayed, whereby the user can notice the approximate time for completing the initialization process.

When the initialization process is completed, the process proceeds to a step S306. In the step S306, a completion confirming screen that indicates that the process is completed is displayed in the display unit 120 of the information processing apparatus 100. An example of the completion confirming screen is the completion confirming screen 316 described above with reference to FIG. 17. After a message indicating that the process is completed is displayed in the completion confirming screen and the user checks this completion confirming screen, the user starts a recording process such as a photographing process.

The step S303 of the sequenced diagram shown in FIG. 20, as described above, is performed for cases of:
(F5) DVD+R DL (VIDEO); and
(F6) DVD-R (VIDEO).

In other words, the step S303 is performed for a case where the loaded disc is DVD+R DL or DVD-R and the SD image recording is selected in the step S301. In this case, as described above with reference to the guide screen 213 shown in of FIG. 9, the previous initialization process is not required.

In this case, in the step S303, a process for confirming that the recording image quality is standard definition (SD) is performed. This process is the same process as the step S204 of the sequence diagram shown in FIG. 11. In other words, in the step S303, a guide screen for confirming that the recording image quality is standard definition (SD) is displayed in the display unit 120 of the information processing apparatus 100. This guide screen is the image quality confirming guide screen 317 described above with reference to FIG. 18. In the guide screen, an attention message of “TO BE RECORDED IN SD (STANDARD) IMAGE QUALITY. NOT TO BE RECORDED IN HIGH VISION IMAGE QUALITY” is displayed.

After checking this message, the user operates an OK icon. When the operation information is input to the control unit, the process proceeds to a step S306. Then, a message indicating the completion of the process is displayed in the completion confirming screen 317 that has been described above with reference to FIG. 17. After checking this screen, the user starts a data recording process such as a photographing process.

(B2) A Case where DVD-RW is Loaded

Next, a guide process in a case where a DVD-RW is loaded in the information processing apparatus will be described.

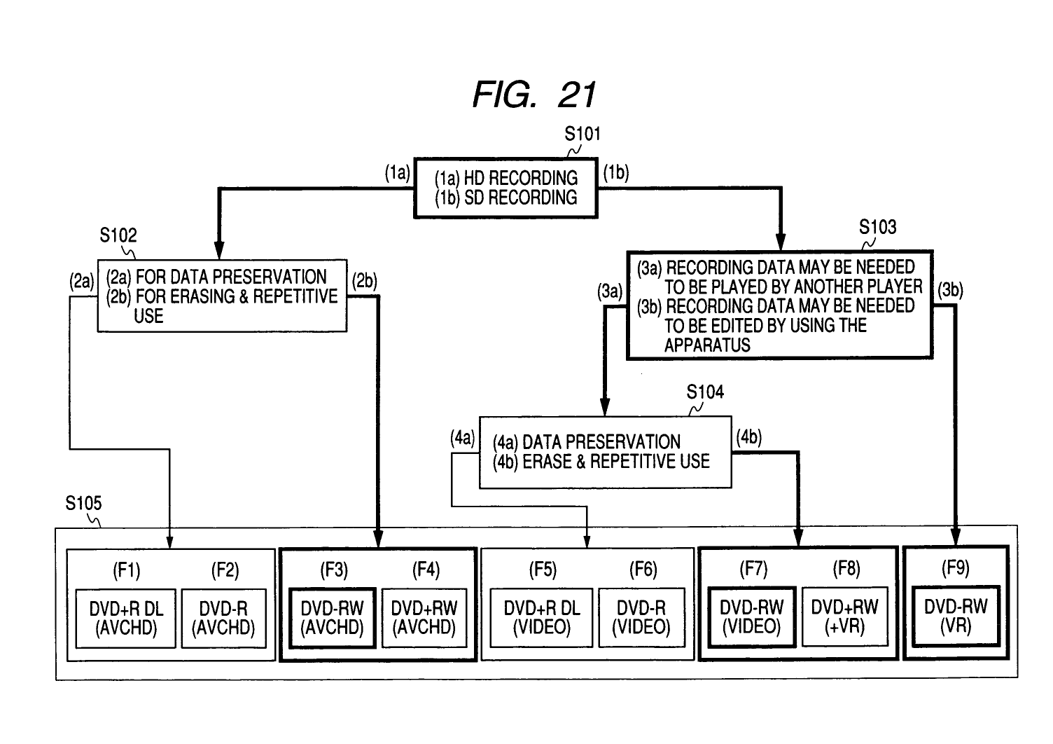

In FIG. 21, a sequence diagram as is described with reference to FIG. 4 is shown. As is understood from FIG. 21, when a DVD-RW is loaded in the information processing apparatus, combinations of a disc type and an application format that are recommended in the information processing apparatus according to an embodiment of the invention are:
(F3) DVD-RW (AVCHD);
(F7) DVD-RW (VIDEO); and
(F9) DVD-RW (VR).

In the sequence diagram shown in FIG. 21, the only steps that determine the difference among (F3), (F7), and (F9) are the determination step S101 for determining whether data recording is HD recording or SD recording and the step S103. Other determination steps are unnecessary when the type of the disc loaded in the information processing apparatus is DVD-RW.

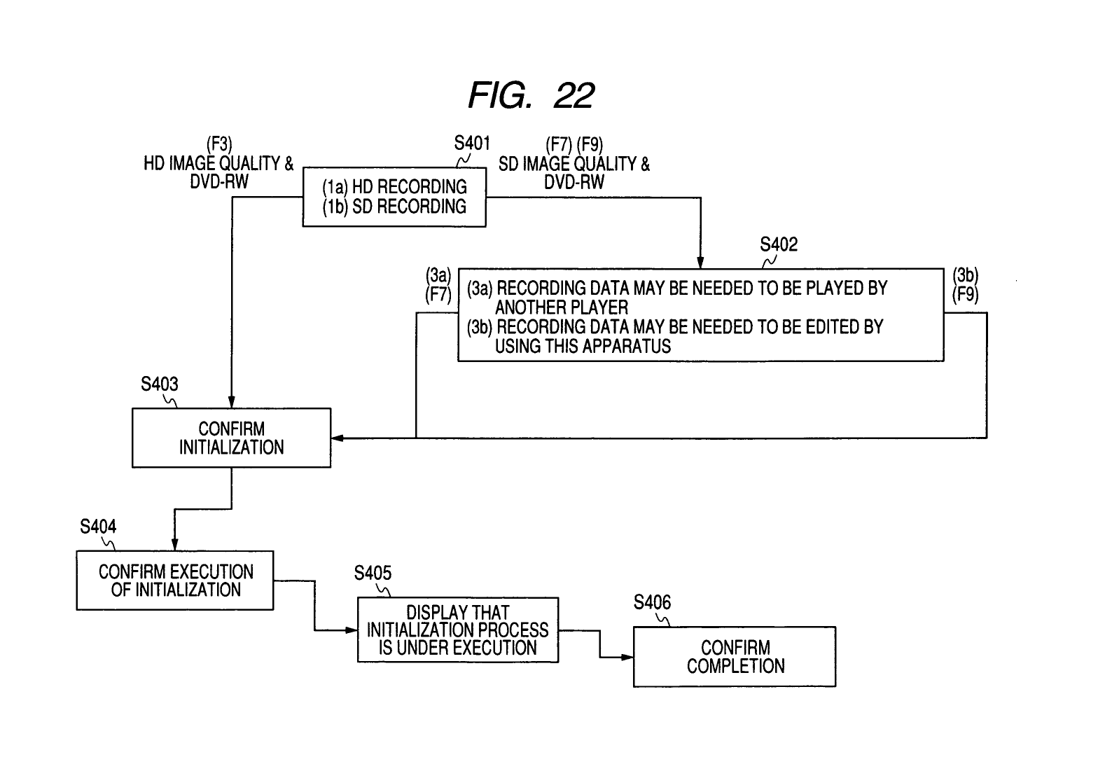

Thus, after one of the three application formats of (F3), (F7), and (F9) to be used is determined by performing the determination processes of the step S101 and the step S103, a same process as the process flow shown in FIG. 11 described above is performed. As a result, the guide process is performed in accordance with a sequence shown in FIG. 22.

Each step of the sequence shown in FIG. 22 will now be described. The process shown in FIG. 22 is performed after a disc is loaded in the information processing apparatus and a process for identifying whether the loaded disc is DVD-RW is performed. In the information processing apparatus, a guide screen in a wizard mode (interactive mode) is displayed in the display unit (display) 120 of the information processing apparatus 100, and the process proceeds in accordance with user's input as a response.

At first, in a step S401, it is inquired of the user whether:
(1a) HD recording as high definition recording is performed; or
(1b) SD recording as standard definition recording is performed.

The configuration of a screen that is used for this inquiry is the image quality checking guide screen 201 described above with reference to FIG. 5. In the image quality checking guide screen 201 shown in FIG. 5 is, as described above, as options for the inquiry of “PLEASE SELECT RECORDING IMAGE QUALITY FOR PHOTOGRAPHING”, two options of “PHOTOGRAPH IN HD (HIGH VISION) IMAGE QUALITY” and “PHOTOGRAPH IN SD (STANDARD) IMAGE QUALITY” are set, and one between the two options is configured to be selected/input by a user.

The user selects one between the options in response to the inquiry. When the control unit of the information processing apparatus 100 detects the user input information, the control unit selects a next guide screen and displays the selected guide screen in the display unit 120. For example, when the user selects “PHOTOGRAPH IN HD (HIGH VISION) IMAGE QUALITY”, the process proceeds to a step S403 in the process sequence diagram shown in FIG. 20. In this case, “(F3) DVD-RW (AVCHD) in which “the image quality is HD and the application format is AVCHD is set.

On the other hand, when the user selects “PHOTOGRAPH IN SD (STANDARD) IMAGE QUALITY” in the step S401, the process proceeds to a step S402. The process proceeds to the step S402 when the image quality is standard definition (SD) and a combination of a disc type and an application format is one between:
(F7) DVD-RW (VIDEO); and
(F9) DVD-RW (VR).

In the step S402, in order to determine one between (F7) and (F9) to be set, it is inquired of the user whether:
(3a) RECORDING DATA MAY BE NEEDED TO BE PLAYED BY ANOTHER PLAYER; or
(3b) RECORDING DATA MAY BE NEEDED TO BE EDITED BY USING THE APPARATUS.

The step S402 is the same process step as the step S103 described above with reference to FIG. 4, and the recording data usage type checking guide screen 203 shown in FIG. 7 is displayed in the display unit 120.

As options for the inquiry of “WHAT WOULD YOU LIKE TO DO AFTER PHOTOGRAPHING?”, two options of “I WANT TO REPRODUCE DATA BY USING VARIOUS DVD APPARATUSES” and “I WANT TO EDIT DATA INCLUDING ERASING AND DIVIDING THE DATA BY USING THIS APPARATUS” are set, and the screen is configured such that one between the two options is selected/input by a user.

The user selects one between the options in response to the inquiry. When the control unit of the information processing apparatus 100 detects the user's input information, the control unit selects an application format to be used on the basis of the detected information. In other words, one between “(F7) DVD-RW (VIDEO)” and “(F9) DVD-RW (VR)” is determined to be set.

In the recording data usage type checking guide screen 203 shown in FIG. 7, when “I WANT TO REPRODUCE DATA BY USING VARIOUS DVD APPARATUSES” is selected, “(F7) DVD-RW (VIDEO)” is set to be used. On the other hand, when “I WANT TO EDIT DATA INCLUDING ERASING AND DIVIDING THE DATA BY USING THIS APPARATUS” is selected, “(F9) DVD-RW (VR)” is set to be used.

By the processes of the steps S401 and S402, which one will be set is determined among:
(F3) DVD-RW (AVCHD);
(F7) DVD-RW (VIDEO); and
(F9) DVD-RW (VR).

Thereafter, the processes for the steps S403 to S406 are performed. The processes for the steps S403 to S406 correspond to the steps S203 and S205 to S207 which have been described with reference to FIG. 11. At first, in the step S403, a confirming process of the initialization process is performed. A guide screen displayed in the display unit 120 of the information processing apparatus 100 in the step S403 is the guide screen 313a that has been described above with reference to FIG. 14.

In this example of the process, the process applies when the user selects high definition (HD) recording, that is, a case where “(F3) DVD-RW (AVCHD)” is set and when the SD recording is selected, that is, a case where “(F7) DVD-RW (VIDEO)” or “(F9) DVD-RW (VR)” is set. Accordingly, when “(F3) DVD-RW (AVCHD)” is set, there is displayed a guide screen 313a in which it is indicated that image recording corresponding to high vision can be performed. On the other hand, when “(F7) DVD-RW (VIDEO)” or “(F9) DVD-RW (VR)” is set, there is displayed a guide screen 313b in which it is not indicated that image recording corresponding to high vision can be performed. In both the cases, there is displayed a processing time that may be required for the initialization process, whereby the user can notice the required time. When the user selects “YES” in response to the initialization process confirming guide screen 313a or 313b, the control unit detects the input selection information, and the process proceeds to the next processing step S404.

The step S404 is for a process for reconfirming the user that the initialization process may be actually performed. When the initialization process is performed, all recorded data is erased, and thus, the performance of the initialization process is reconfirmed. At this time, a guide screen displayed in the display unit 120 of the information processing apparatus 100 is the confirming guide screen 314 described above with reference to FIG. 15. In the step S404, a confirming guide screen 314 shown in FIG. 15 that allows the user to input one between “YES” and “NO” for reconfirming that the initialization process may be performed is displayed.

When the user input “YES” in the confirming guide screen 314, the control unit detects the input information, and the process proceeds to the next step S405. The step S405 is for performing the initialization process. In the initialization process performing step, a guide screen indicating the initialization process is under execution is displayed in the display unit 120 of the information processing apparatus 100. An example of the guide screen is the guide screen 315 described above with reference to FIG. 16.

In the step S405, as shown in FIG. 16, a guide screen 315 indicating the initialization process is under execution is displayed. In the guide screen 315, an attention message of “EXECUTION OF INITIALIZATION PROCESS IN PROGRESS. DO NOT APPLY ANY SHOCK” is displayed, and a remaining time for the initialization process is also displayed, whereby the user can notice the approximate time for completing the initialization process.

When the initialization process is completed, the process proceeds to a step S406. In the step S406, a completion confirming screen that indicates that the process is completed is displayed in the display unit 120 of the information processing apparatus 100. An example of the completion confirming screen is the completion confirming screen 316 described above with reference to FIG. 17. After a message indicating that the process is completed is displayed in the completion confirming screen and the user checks this completion confirming screen, the user starts a recording process such as a photographing process.
(B3) A Case Where DVD+RW Is Loaded

Next, a guide process in a case where a DVD-RW is loaded in the information processing apparatus will be described.

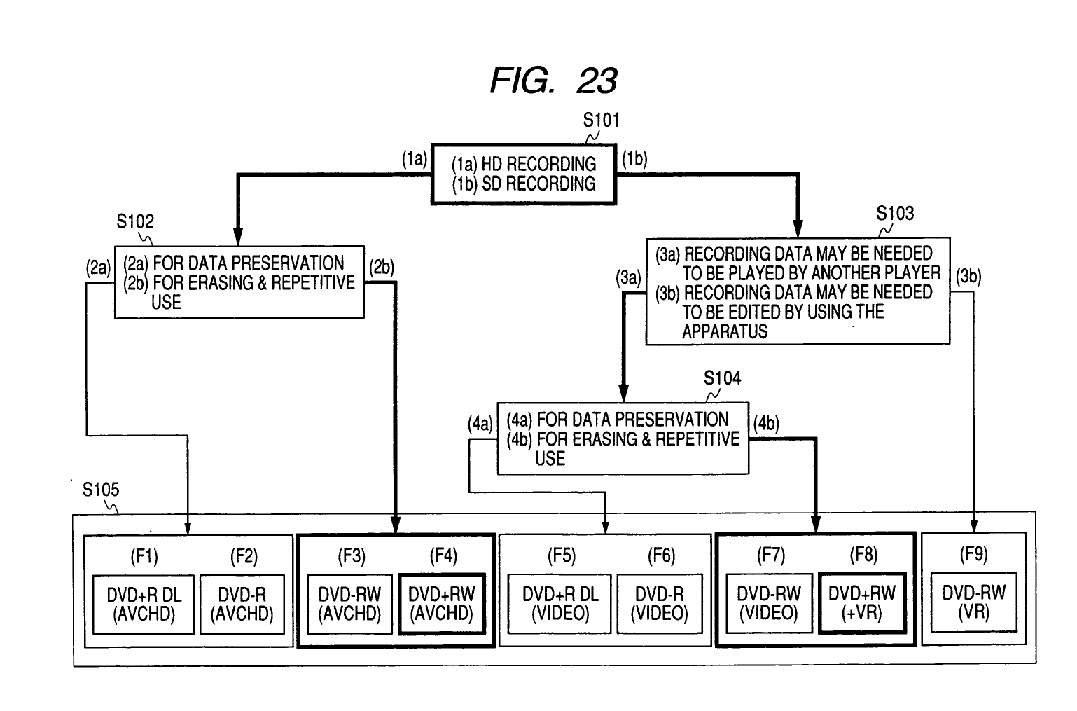

In FIG. 23, a sequence diagram as is described with reference to FIG. 4 is shown. As is understood from FIG. 23, when a DVD+RW is loaded in the information processing apparatus, combinations of a disc type and an application format that are recommended by the information processing apparatus according to an embodiment of the invention are:
(F4) DVD+RW (AVCHD); and
(F8) DVD+RW (+VR).

In the sequence diagram shown in FIG. 23, the only step that determines the difference between (F4) and (F8) is the determination step S101 for determining whether data recording is HD recording or SD recording. Other determination steps S102 to S104 are unnecessary when the type of the disc loaded in the information processing apparatus is DVD+RW.

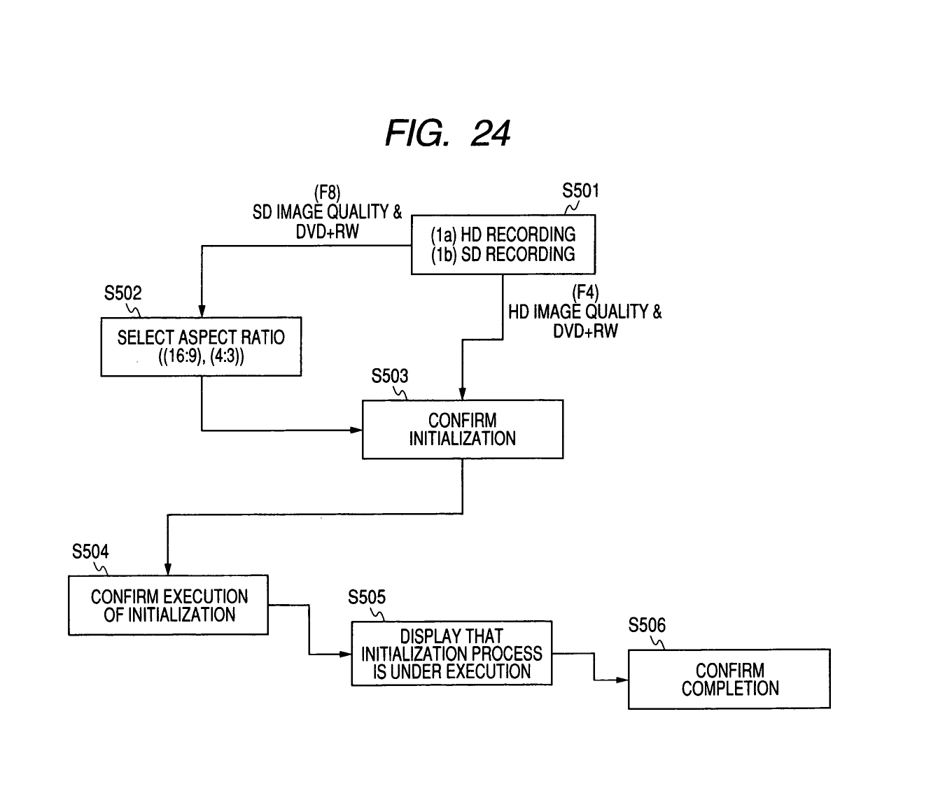

Thus, after one between (F4) and (F8) to be used is determined by performing the determination process of the step S101, a same process as the process flow shown in FIG. 11 described above is performed. As a result, the guide process is performed in accordance with a sequence shown in FIG. 24.

Each step of the sequence shown in FIG. 24 will now be described. The process shown in FIG. 24 is performed after a disc is loaded in the information processing apparatus and a process for identifying whether the loaded disc is DVD+RW is performed. In the information processing apparatus, a guide screen in a wizard mode (interactive mode) is displayed in the display unit (display) 120 of the information processing apparatus 100, and the process proceeds in accordance with user's input as a response.

At first, in a step S501, it is inquired of the user whether:
(1a) HD recording as high definition recording is to be performed; or
(1b) SD recording as standard definition recording is to be performed.

The configuration of a screen that is used for this inquiry is the image quality checking guide screen 201 described above with reference to FIG. 5. In the image quality checking guide screen 201 shown in FIG. 5, as described above, as options for the inquiry of “PLEASE SELECT RECORDING IMAGE QUALITY FOR PHOTOGRAPHING”, two options of “PHOTOGRAPH IN HD (HIGH VISION) IMAGE QUALITY” and “PHOTOGRAPH IN SD (STANDARD) IMAGE QUALITY” are set, and one between the two options is configured to be selected/input by a user.

The user selects one between the options in response to the inquiry. When the control unit of the information processing apparatus 100 detects the user input information, the control unit determines which one between “(F4) DVD+RW (AVCHD)” and “(F8) DVD+RW (+VR)” will be used for setting.
For example, when the user selects “PHOTOGRAPH IN HD (HIGH VISION) IMAGE QUALITY”, “(F4) DVD+RW (AVCHD)” is set.

On the other hand, when the user selects “PHOTOGRAPH IN SD (STANDARD) IMAGE QUALITY”, “(F8) DVD+RW (+VR)” is set.

After the determination processes, the control unit selects a next guide screen and displays the selected guide screen in the display unit 120. For example, when “PHOTOGRAPH IN HD (HIGH VISION) IMAGE QUALITY” is selected, the process proceeds to a step S503 of the process sequence diagram shown in FIG. 24.

On the other hand, when “PHOTOGRAPH IN SD (STANDARD) IMAGE QUALITY” is selected, the process proceeds to a step S502.

The process of the step S502 will now be described. The process proceeds to the step S502 for a case of “(F8) DVD+RW (+VR)”, that is, a case where SD image quality is selected and the loaded disc is a DVD+RW. In this case, selection of the aspect ratio of a motion picture to be recorded is requested to the user in the step S502. The process of the step S502 corresponds to that of the step S202 described above with reference to FIG. 11 and requests the user to select the aspect ratio of the motion picture to be recorded.

An example of the guide screen displayed in the display unit 120 of the information processing apparatus 100 in this step S502 is the guide screen 312 described above with reference to FIG. 13.

A request of “PLEASE SELECT ASPECT RATIO FOR MOTION PICTURE TO BE RECORDED ON THIS DISC. THE ASPECT RATIO CAN BE CHANGED WHEN REINITIALIZED” appears in the aspect ratio selection requesting guide screen 312, and as options, two options of: “16:9” and “4:3” are displayed, and the user selects any one between the options. When the control unit of the information processing apparatus detects a response to the request, the process proceeds to the step S503 of the sequence diagram shown in FIG. 24.

The processes for the steps S503 to S506 correspond to those of the steps S203, S205 to S207 described with reference to FIG. 11. At first, in the step S503, a confirming process of the initialization process is performed. A guide screen displayed in the display unit 120 of the information processing apparatus 100 in the step S503 is the guide screen 313a or 313b described above with reference to FIG. 14.

When the user selects high definition (HD) recording, that is, when “(F4) DVD+RW (AVCHD)” is set, the guide screen 313a in which it is indicated that image recording corresponding to high vision can be performed is displayed.

When the user selects standard definition (SD) recording, that is, when “(F8) DVD+RW (+VR)” is set”, the guide screen 313b in which it is not displayed that image recording corresponding to high vision can be performed is displayed.

Since a processing time that may be required for the initialization process is displayed in the guide screen, the user can notice the required time. When the user select “YES” in the initialization process confirming the guide screen 313a or 313b, the control unit detects the selection input information, and the process proceeds to the next step S504 to be processed.

The step S504 is for a process for reconfirming the user that the initialization process maybe actually performed. When the initialization process is performed, all recorded data is erased, and thus, the performance of the initialization process is reconfirmed. At this time, a guide screen displayed in the display unit 120 of the information processing apparatus 100 is the confirming guide screen 314 described above with reference to FIG. 15. In the step S504, a confirming guide screen 314 shown in FIG. 15 that allows the user to input one between “YES” and “NO” for reconfirming that the initialization process may be performed is displayed.

When the user input “YES” in the confirming guide screen 314, the control unit detects the input information, and the process proceeds to the next step S505. The step S505 is for performing the initialization process. In the initialization process performing step, a guide screen indicating the initialization process is under execution is displayed in the display unit 120 of the information processing apparatus 100. An example of the guide screen is the guide screen 315 described above with reference to FIG. 16.

In the step S505, as shown in FIG. 16, a guide screen 315 indicating the initialization process is under execution is displayed. In the guide screen 315, an attention message of “EXECUTION OF INITIALIZATION PROCESS IN PROGRESS. DO NOT APPLY ANY SHOCK” is displayed, and a remaining time for the initialization process is also displayed, whereby the user can notice the approximate time for completing the initialization process.

When the initialization process is completed, the process proceeds to a step S506. In the step S506, a completion confirming screen that indicates that the process is completed is displayed in the display unit 120 of the information processing apparatus 100. An example of the completion confirming screen is the completion confirming screen 316 described above with reference to FIG. 17. After a message indicating that the process is completed is displayed in the completion confirming screen and the user checks this completion confirming screen, the user starts a recording process such as a photographing process.

(C) For Case where Unused Disc is Loaded in the Information Processing Apparatus (Compulsive Driving)

A compulsive driving process that is performed when an unused disc is loaded in the information processing apparatus will be described. The compulsive driving process is performed when an unused disc is loaded in the information processing apparatus. In this case, it is apparent that the user loaded the disc not for reproduction but for recording new data. In this case, when a condition that an unused disc is identified after being loaded is satisfied, the process for a case of above-described “(B)” where a used disc is loaded in the information processing apparatus described above is forcedly performed automatically.

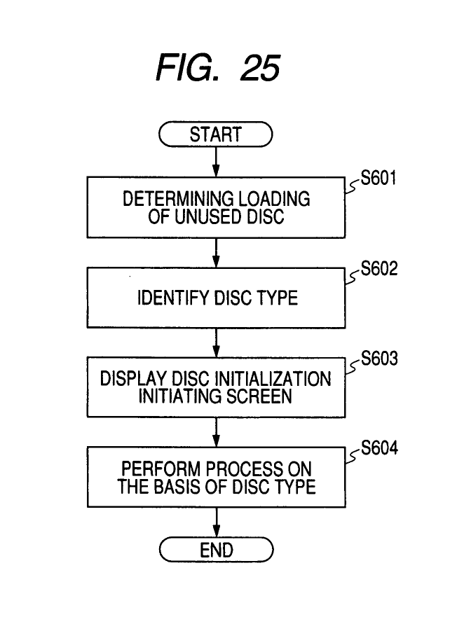

The process performed by the information processing apparatus will now be described with reference to a flowchart shown in FIG. 25. At first, after determining that an unused disc is loaded in a step S601, the information processing apparatus identifies the disc type (for example, DVD-R, DVD+R, DVD-RW, DVD+RW, DVD+R DL, or the like) in a step S602.

Next, in a step S603, a message indicating the start of a disc initialization process is displayed in the display unit. Then, in a step S604, a process in accordance with the disc type, to be more specific, a process in accordance with the sequence diagram of FIG. 20, 22, or 24 in which the process for a case of “(B)” where a used disc is loaded in the information processing apparatus is described is selected and performed in accordance with the disc type.

As described above, in cases of “(B) USED DISC IS LOADED IN INFORMATION PROCESSING APPARATUS” and “(C) UNUSED DISC IS LOADED IN INFORMATION PROCESSING APPARATUS (COMPULSIVE DRIVING)”, the disc type is identified and the process in accordance with the sequence diagram of FIG. 20, 22, or 24 is performed on the basis of the identified disc type. As can be understood from the processes, the user can select an optimal disc and an optimal application format in accordance with the usage type of the disc by only sequentially responding to inquiries displayed in the display unit of the information processing apparatus 100, and processes that may be required after the selection can be performed assuredly, whereby a data recording operation in which the optical application format is used for the optical disc can be started smoothly.

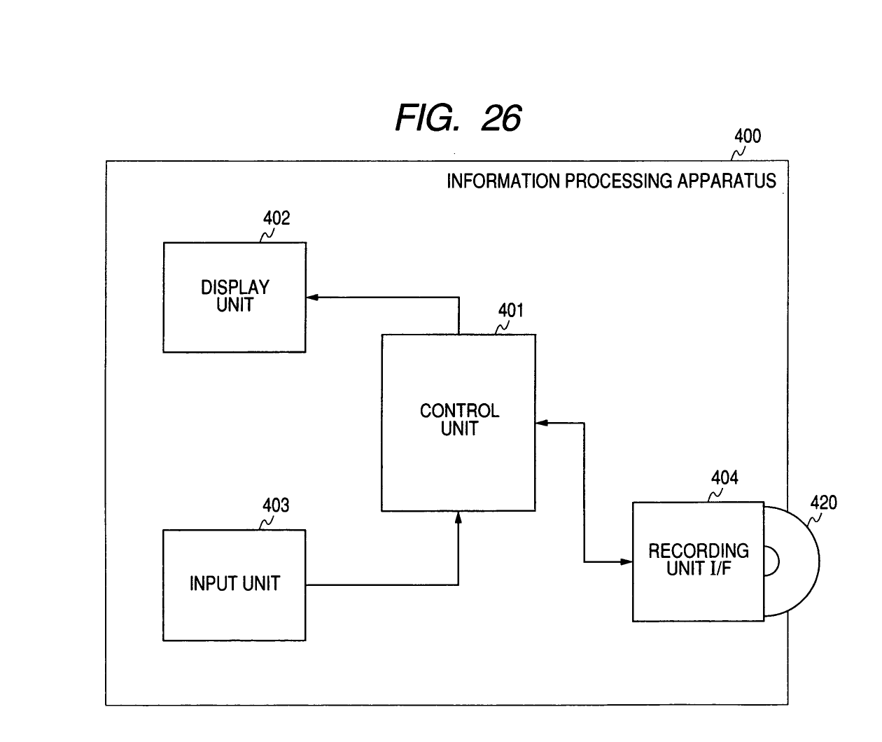

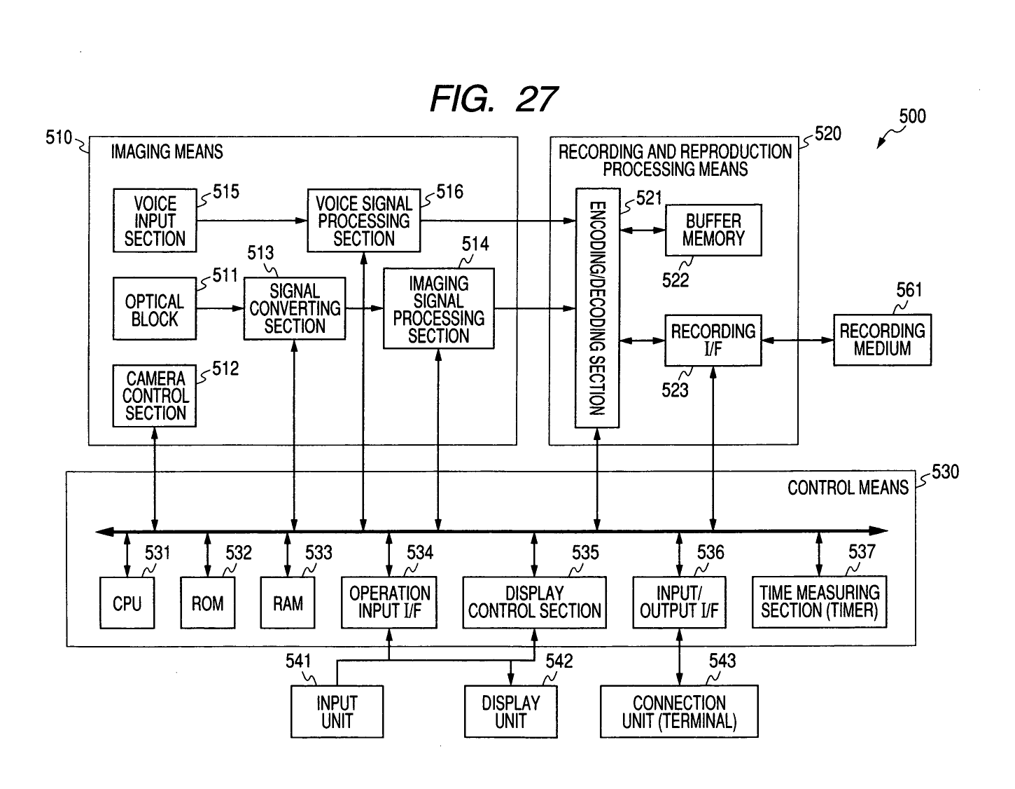

The configuration of an information processing apparatus according to an embodiment of the invention will now be described with reference to FIGS. 26 and 27. FIG. 26 is a functional block diagram for describing a functional configuration performing the above-described processes. FIG. 27 is diagram showing an example of a hardware configuration of an imaging apparatus as an example of an information processing apparatus according to an embodiment of the invention.

At first, the function of the information processing apparatus according to an embodiment of the invention will be described with reference to FIG. 26. The block diagram shown in FIG. 26 shows a functional configuration that may be required for performing the above-described processes. As shown in FIG. 26, the information processing apparatus 400 according to an embodiment of the invention includes a control unit 401, a display unit 402, an input unit 403, and a recording unit interface 404 in which various types of discs can be loaded. Data recording on the disc 420 is performed through the interface 404.

The control unit 401, for example, is a CPU and performs a guide display process for the above-described display unit 402, a user input information detecting process through the input unit 403, and a determination process for a disc type or an application format.

The display unit 402 is a display that performs display processes for various guide screens described in the above-described embodiments. The input unit 403 receives operation information such as an input in response to a guide screen and the like. When the display unit 402 is configured to have an input function such as a touch panel method, the input unit 403 is integrated with the display unit 402.

The control unit 401 displays guide information configured as an interactive more for a user in the display unit 402 and performs an analysis process for a user's input through the input unit 403. Described in more details, the usage type of the recording data for the disc is determined on the basis of the user's input in response to the guide information displayed in the display unit 402, and a process that determines at least one of the disc type and the application format that is to be used for the recording process is performed. As described with reference to FIG. 4, the usage type of the recording data for the disc is determined on the basis of the user's input in response to the guide information displayed in the display unit 402 and the setting information on the combination of an optimal disc type and an optimal application format on the basis of the usage type of the recording data for the disc, that is, the setting information of:
(F1) DVD+R DL (AVCHD);
(F2) DVD-R (AVCHD);
(F3) DVD-RW (AVCHD);
(F4) DVD+RW (AVCHD);
(F5) DVD+R DL (VIDEO)
(F6) DVD-R (VIDEO);
(F7) DVD-RW (VIDEO);
(F8) DVD+RW (+VR); and
(F9) DVD-RW (VR).

Then, a process that determines at least one of the disc type and the application format that is to be used for the recording process is performed.

The control unit 401, for example, displays the image quality checking guide screen, as described with reference to FIG. 5, that checks a desired recording between high definition (HD) recording and standard definition (SD) recording, a disc usage type checking guide screen, as described with reference to FIG. 6, that checks whether preservation of data recorded on a disc may be or erasing data recorded on a disc and reusing the disc may be required, a recording data usage type checking screen, as described with reference to FIG. 7, that checks whether reproduction of the data recorded on the disc is to be performed by another apparatus or editing of the data recorded on the disc in the information processing apparatus is to be performed, and the like in the display unit 402. Then, the control unit 401 performs a process that determines at least one of the disc type and the application format to be used for the recording process on the basis of the user's input in response to the guide screen.

In addition, the control unit 401 determines a usage type of recording data for a disc on the basis of the user input for the guide information displayed in the display unit 402 for determining a recommended disc type that is appropriate for the recording process in a case where a disc is not loaded in the information processing apparatus and displays a disc loading request guide screen in the display for prompting loading of a disc corresponding to the determined disc type. For example, the disc loading request guide screen is the disc loading request guide screen 311 shown in FIG. 12, and an identification mark corresponding to each disc type is included in the display.

In addition, the control unit 401 identifies a disc type of a loaded disc in a case where the disc is loaded in the information processing apparatus and performs a process of determining an application format that will be used for a recording process for the identified disc on the basis of a user input for the guide information displayed in the display unit 402. When the loaded disc is detected to be an unused disc, the control unit 401 displays guide information after displaying an initiating screen for an initialization process in the display unit 402.

An example of a hardware configuration of an imaging apparatus as an information processing apparatus according to an embodiment of the invention will now be described in detail with reference to FIG. 27. As shown in FIG. 27, the imaging apparatus 500 includes an imaging means 510, a recording and reproduction processing means 520, and a control means 530 as primary blocks. In addition, the imaging apparatus 500 includes a recording medium 561, and input unit 541, a display unit 542 for displaying the guide information described in the above-described embodiments, and a connection unit (terminal) 543 for connection to external devices.

The control unit 401 shown in FIG. 26 corresponds to the control means 530 shown in FIG. 27. The display unit 402 shown in FIG. 26 corresponds to the display unit 542 shown in FIG. 27. The input unit 403 shown in FIG. 26 corresponds to the input unit 541 shown in FIG. 27.

The imaging means 510 includes an optical block 511, a camera control section 512, a signal converting section 513, an imaging signal processing section 514, a voice input section 515, and a voice signal processing section 516. The optical block 511 includes a lens group for photographing a subject, an iris control mechanism, a focus control mechanism, a zoom mechanism, a shutter mechanism, a flash mechanism, a hand blur correcting mechanism, and the like. The camera control section 512 receives a control signal from the control means 530 as an input and generates a control signal to be supplied to the optical block 511. In addition, the camera control section 512 supplies the generated control signal to the optical block 511 for performing a zoom control operation, a shutter control operation, an exposure control operation, and the like.

The signal converting section 513, for example, includes an imaging device such as CCD (Charge Coupled Device), and on an imaging surface thereof, an image is formed through the optical block 511. The signal converting section 513 receives an image input timing signal supplied from the control means 530 in accordance with a shutter operation, converts a subject image formed on the imaging surface into an image signal, and supplies the image signal to the imaging signal processing section 514.

The imaging signal processing section 514 performs processes including a gamma correction, AGC (Auto Gain Control) for the image signal, and the like and performs a conversion process for converting the image signal into a digital image signal on the basis of a control signal transmitted from the control unit 530. The voice input section 515 collects voices around the subject at a time of photographing. A voice signal from the voice input section 515 is supplied to a voice signal processing section 516. The voice signal processing section 516 performs processes including a gamma correction, AGC (Auto Gain Control), and the like for the voice signal on the basis of the control signal transmitted from the control unit 530 and performs a conversion process for converting the voice signal into a digital signal.

The recording and reproduction processing means 520 includes an encoding/decoding section 521, a buffer memory 522, and a recording section interface 523. The buffer memory 522, for example, includes an SDRAM or the like and is used as a work area for an encoding or decoding operation performed by the encoding/decoding section 521. The encoding/decoding section 521 has an encoding function of encoding/multiplexing the image signal, the voice signal, or additional recording information, that have been transmitted from the imaging means 510, to be converted into compressed data. The encoding/decoding section 521 also has a decoding function of separating the image signal, the voice signal, or the additional recording information from the compressed data to be decoded. In addition, encoding/decoding section 521 performs an automatic white balance control process, an exposure correction control process, an enlargement control process according to digital zoom magnification, and the like for the image signal transmitted from the imaging signal processing section 514 on the basis of a control signal from the control means 530.

The recording section interface 523 receives the compressed data from the encoding/decoding section 521 and stores the compressed data on the recording medium 561. In addition, the recording section interface 523 reads out the compressed data from the recording medium 561 and supplies the compressed data to the encoding/decoding section 521 or the control means 530.

The control means 530 outputs data that is decoded by the encoding/decoding section 521 through an input/output I/F 536 to an external device such as a television set that is connected through a cable attached to the connection unit (terminal) 543.

The control means 530 includes a CPU 531 for executing various control programs, a ROM (Read Only Memory) 532, a RAM (Random Access Memory) 533, an operation input interface 534 for connection to the input unit 541, a display control section 535 for display control of the display unit 542 that displays various guide information described above, an input/output I/F 536 for performing data input/output using the connection unit 543, and a clock circuit 537, for example, for checking imaging time which are connected with one another through a system bus. Information on the user's operation in the display unit 542 is input to the CPU 531 through the operation input interface 534, and a control operation is performed on the basis of the input information.

The control means 530, as described above with reference to the figure, performs processes of displaying various guide information in the display unit 542, determining the usage type of recording data for a disc used as a recording medium 561 on the basis of user's input in response to the guide information displayed in the display unit 542, and determining at least one of a disc type or an application format to be used for a recording process.

The CPU 531 is responsible for the whole processes of the control means 530 and uses the RAM 533 as a work area. In the ROM 532, a program for controlling the imaging means 510 or a program for performing recording control and reproduction control processes for an image signal or a voice signal, the above-described guide information display process, a process for determination of the disc type and the application format, or the like is stored.

To the operation input interface 534, input information from various operation units of the imaging device, for example, a plurality of operation units such as a zoom control key, an exposure control key, a shutter key, and a motion picture pickup key along with the user's input from the input unit 541, for example, the user's input in response to the above-described guide display is input.

The display unit 542 connected to the display control section 535, for example, includes an LCD (Liquid Crystal Display) or the like. The display unit 542 displays an image signal from the imaging means 510, an image signal read-out from the recording medium 560, and the above-described guide information under the control of the control means 530. The display unit 542 may be configured as a user interface to which user's operation information can be input.

The imaging apparatus 500 shown in FIG. 27 is an example of an information processing apparatus according to an embodiment of the invention, and, as described above, the present invention is not limited to an imaging apparatus and may be applied to an apparatus that performs data input/output operations through cable connection. The information processing apparatus according to an embodiment of the invention includes the whole apparatuses that perform data input/output operations such as a video cassette recorder and a DVD reproducing device.

The present invention has been described above in detail with reference to specific embodiments. However, it is apparent to those skilled in the art that various changes or substitutions may be made therein without departing from the gist of the invention. In other words, the present invention is disclosed as an exemplary form, and therefore, the invention should not be construed as being limited to the embodiments. In order to determine the gist of the invention, the appended claims should be referred to.

A series of processes described above may be performed by a hardware configuration, a software configuration, or a combined configuration thereof. The processes may be performed by software by installing a program in which the process sequence is recorded in a memory installed in dedicated hardware inside a computer for being executed or by installing the program in a general-purpose computer that can execute various processes for being installed.

For example, the program may be stored in a hard disk or a ROM (Read Only Memory) as a recording medium in advance. Moreover, the program may be stored (recorded) temporary or permanently in a removable recording medium such as a flexible disc, a CD-ROM (Compact Disc Read Only Memory), an MO (Magneto optical) disc, a DVD (Digital Versatile Disc), a magnetic disc, and a semiconductor memory. The removable recording medium may be provided as so-called package software.

The program may be wirelessly transmitted to a computer from a download site or transmitted to a computer using wired communication through a network such as a LAN (Local Area Network) and the Internet instead of being installed in a computer from a removable recording medium as described above, and the computer may receive the transmitted program and install the program in a recording medium such as an internal hard disk.

Various processes described above may be performed in a time series as described or performed in parallel or independently on the basis of processing capability of apparatuses performing the processes or as may be needed. A system in description of an embodiment of the invention is a configuration of a logical set of a plurality of devices and not limited to a configuration in which all the devices are integrated in the same body.

As described above, according to a configuration of an embodiment of the present invention, since there is used a configuration in which guide information configured as an interactive mode for a user is displayed in the display unit, user input through the input unit is analyzed, a usage type of recording data for the disc is determined on the basis of user input in response to the guide information displayed in the display unit, and a disc type or an application format to be used for data recording is determined, the user can select an optimal disc and an optimal application format in accordance with the usage type of recording data by only sequentially responding to inquiries displayed in the display unit of the information processing apparatus, processes that may be required after the selection can be performed assuredly, and a data recording operation in which the optical application format is used for the optical disc can be started smoothly, whereby an information recording processing apparatus is implemented.

It should be understood by those skilled in the art that various modifications, combinations, sub-combinations and alterations may occur depending on design requirements and other factors insofar as they are within the scope of the appended claims or the equivalents thereof.

1. An information processing apparatus that loads a disc as a recording medium and performs a data recording process on the disc, the information processing apparatus comprising:
a display unit performing an information display process; and
a control unit displaying guide information including predetermined inquiry information for a user in the display unit and performing an analysis process for a user's input that is input through an input unit in response to the displayed guide information,
wherein the control unit is configured to determine a usage type of recording data for the disc on the basis of the user's input in response to the guide information displayed in the display unit and determine at least one of a disc type and an application format that is to be used for the recording process.

2. The information processing apparatus according to claim 1, wherein, on the basis of setting information on a combination of the disc type and the application format optimal for the usage type of the recording data for the disc, the control unit is configured to determine the usage type of the recording data for the disc in accordance with the user's input in response to the guide information displayed in the display unit and determine at least one of a disc type and an application format that is to be used for the recording process.

3. The information processing apparatus according to claim 1, wherein the guide information includes at least inquiry information on an image quality of the recording data.

4. The information processing apparatus according to claim 1, wherein the guide information includes at least inquiry information on an editing process for the recording data to be recorded on the disc.

5. The information processing apparatus according to claim 1, wherein the guide information includes at least inquiry information on whether the disc on which the recording data is recorded is to be reproduced using an apparatus other than the information processing apparatus.

6. The information processing apparatus according to claim 1, wherein the guide information includes at least inquiry information on whether the recording data is to be repeatedly recorded on the disc.

7. The information processing apparatus according to claim 1, wherein the control unit is configured to display an image quality checking guide screen for inquiring a desired recording type between a high definition (HD) recording type and a standard definition (SD) recording type in the display unit and determine at least one of the disc type and the an application format that is to be used for the recording process on the basis of the user's input in response to the image quality checking guide screen.

8. The information processing apparatus according to claim 1, wherein the control unit is configured to display a disc usage checking guide screen for inquiring whether preservation of the data to be recorded on the disc may be required or deletion of the data recorded on the disc and reuse of the disc may be required in the display unit and determine at least one of the disc type and the application format that is to be used for the recording process on the basis of the user's input for the disc usage checking guide screen.

9. The information processing apparatus according to claim 1, wherein the control unit is configured to display a recording data usage type checking guide screen for inquiring whether the data to be recorded on the disc is to be reproduced by an apparatus other than the information processing apparatus or is to be edited by the information processing apparatus in the display unit and determine at least one of the disc type and the application format that is to be used for the recording process on the basis of the user's input in response to the recording data usage type checking guide screen.

10. The information processing apparatus according to claim 1, wherein the control unit is configured to determine the usage type of the recording data for the disc on the basis of user's input in response to the guide information displayed in the display unit, determine a recommended disc type that is appropriate for the recording process, and display a disc loading requesting guide screen in the display unit for prompting loading of the determined disc type when the disc is not loaded in the information processing apparatus.

11. The information processing apparatus according to claim 10, wherein the control unit is configured to display an identification mark corresponding to each disc type in the disc loading requesting guide screen.

12. The information processing apparatus according to claim 1, wherein the control unit is configured to identify the type of a loaded disc and determine the application format to be used for the recording process for the disc of which type is identified on the basis of the user's input in response to the guide information displayed in the displayed unit when the disc is loaded in the information processing apparatus.

13. The information processing apparatus according to claim 1, wherein the control unit is configured to display an initiating screen for an initialization process in the display unit, display the guide information in the display unit, determine the usage type of the recording data for the disc on the basis of the user's input in response to the guide information, and determine the application format to be used for the recording process when it is detected that the disc loaded in the information processing apparatus is an unused disc.

14. An information processing method using an information processing apparatus that loads a disc as a recording medium and performs a data recording process on the disc, the information processing method comprising the steps of:
displaying guide information including predetermined inquiry information for a user in the display unit using a control unit; and
performing a determination process using the control unit to decide at least one of a disc type and an application format that is to be used for the recording process by determining a usage type of recording data for the disc on the basis of an analysis process for the user's input through the input unit in response to the guide information, using the control unit.

15. The information processing method according to claim 14, wherein the determination process performing step determines the usage type of the recording data for the disc in accordance with the user's input in response to the guide information and determines at least one of a disc type and an application format that is to be used for the recording process, on the basis of setting information on a combination of the disc type and the application format optimal for the usage type of the recording data for the disc.

16. The information processing method according to claim 14, wherein the guide information includes at least inquiry information on an image quality of the recording data.

17. The information processing method according to claim 14, wherein the guide information includes at least inquiry information on an editing process for the recording data to be recorded on the disc.

18. The information processing method according to claim 14, wherein the guide information includes at least inquiry information on whether the disc on which the recording data is recorded is to be reproduced using an apparatus other than the information processing apparatus.

19. The information processing method according to claim 14, wherein the guide information includes at least inquiry information on whether the recording data is to be repeatedly recorded on the disc.

20. The information processing method according to claim 14, wherein the determination process performing step includes displaying an image quality checking guide screen for inquiring a desired recording type between a high definition (HD) recording type and a standard definition (SD) recording type in the display unit and determining at least one of the disc type and the an application format that is to be used for the recording process on the basis of the user's input in response to the image quality checking guide screen.

21. The information processing method according to claim 14, wherein the determination process performing step includes displaying a disc usage checking guide screen for inquiring whether preservation of the data to be recorded on the disc may be required or deletion of the data recorded on the disc and reuse of the disc may be required in the display unit and determining at least one of the disc type and the application format that is to be used for the recording process on the basis of the user's input for the disc usage checking guide screen.

22. The information processing method according to claim 14, wherein the determination process performing step includes displaying a recording data usage type checking guide screen for inquiring whether the data to be recorded on the disc is to be reproduced by an apparatus other than the information processing apparatus or is to be edited by the information processing apparatus in the display unit and determining at least one of the disc type and the application format that is to be used for the recording process on the basis of the user's input in response to the recording data usage type checking guide screen.

23. The information processing method according to claim 14, further comprising:
determining the usage type of the recording data for the disc on the basis of user's input in response to the guide information displayed in the display unit, determining a recommended disc type that is appropriate for the recording process, and displaying a disc loading requesting guide screen in the display unit for prompting loading of the determined disc type under the control of the control unit when the disc is not loaded in the information processing apparatus.

24. The information processing method according to claim 23, wherein the guide information displaying step displays an identification mark corresponding to each disc type in the disc loading requesting guide screen.

25. The information processing method according to claim 14, further comprising:
identifying the type of a loaded disc and determining the application format to be used for the recording process for the disc of which type is identified on the basis of the user's input in response to the guide information displayed in the displayed unit, by using the control unit, when the disc is loaded in the information processing apparatus.

26. The information processing method according to claim 14, further comprising:
displaying an initiating screen for an initialization process in the display unit, displaying the guide information in the display unit, determining the usage type of the recording data for the disc on the basis of the user's input in response to the guide information, and determining the application format to be used for the recording process, using the control unit, when it is detected that the disc loaded in the information processing apparatus is an unused disc.

27. A computer program performing an information process using an information processing apparatus that loads a disc as a recording medium and performs a data recording process on the disc, the computer program performing:
displaying guide information including predetermined inquiry information for a user in the display unit using a control unit; and
performing a determination process using the control unit to decide at least one of a disc type and an application format that is to be used for the recording process by determining a usage type of recording data for the disc on the basis of an analysis process for the user's input through the input unit in response to the guide information, using the control unit.
